(19) United States
(12) Patent Application Publication
(10) Pub. No.: US 2012/0021111 A1
(43) Pub. Date: Jan. 26, 2012

(54) Natural Low Caloric Sweetener Compositions for Use in Beverages, Foods and Pharmaceuticals, and Their Methods of Manufacture

(75) Inventors: William R. Pfister, Robbinsville, NJ (US); Sanjay Sehgal, West Chester, PA (US)

(73) Assignee: Aexelon Therapeutics, Inc., Exton, PA (US)

(21) Appl. No.: 13/189,501

(22) Filed: Jul. 23, 2011

Related U.S. Application Data
(60) Provisional application No. 61/367,360, filed on Jul. 23, 2010.

(51) Int. Cl. A23L 1/236

(52) U.S. Cl. 426/548; 426/456

(57) ABSTRACT

Natural sweetener compositions, comprising a highly purified steviol extract of rebaudioside A (Reb A) of about 80 to 99% purity, other steviol glycosides of about 3% or less, and sterebins of 1% or less, and one or more bulking agents, where the natural sweetener compositions are suitable for use as an ingredient in orally administered pharmaceuticals, foods, beverages, and other orally administered products, for humans and animals. A method of preparing naturally sweetened orally administered products, comprising the step of mixing natural sweetener compositions, having a highly purified steviol extract and one or more bulking agents, with other ingredients commonly used in manufacturing orally administered products. A process to prepare natural sweetener compositions, comprising the steps of combining a highly purified Stevia extract, having a pure primary steviol glycoside, and one or more bulking agents, with optional additives, and mixing, dissolving, drying, granulating and sieving the resulting composition.

### CROSS-REFERENCE TO RELATED APPLICATION

This application claims the priority benefit of U.S. Provisional Application No. 61/367,360 filed on Jul. 23, 2010 by the present inventors, which is incorporated herein by reference.

### BACKGROUND

There is an increasing interest in natural, low-calorie sugar substitutes, stemming partially from increasing consumer interest in such products. It is also from the rise of retail and internet stores selling natural products, and suppliers' requirements to certify the use of natural ingredients. In addition to tabletop sweeteners, consumers seek natural alternatives for the breadth of orally administered products such as dietary and nutritional supplements. Natural, zero to low calorie sugar substitutes are also desirous for their ability to have no sodium, low or no carbohydrates, and zero glycemic index implications (i.e., not increase blood glucose levels.) Orally administered products sweetened with natural, zero to low-calorie sweeteners, especially pharmaceutical products, can be suitable for dieters, diabetics, and all others mindful of their caloric and sugar intakes. Such products also provide animal owners with an all natural sweetener to mask the bitter taste of some veterinary oral pharmaceutical products. Hence, a need exists for natural sweetener compositions having minimal bitterness and zero or low calories and carbohydrates, for use in foods, beverages, pharmaceuticals, nutritional and dietary supplements, and herbal products and all other orally administered products.

The present inventors were motivated to address the increasing desire for natural, low-calorie sugar substitutes. They were especially motivated to provide much needed solutions for diabetics who have to take medicines and/or pharmaceutical products (e.g., cough, cold mixtures, syrups, and solutions that are loaded with sugars) or require low calorie sweeteners, and for elderly patients, dieters, and pediatric populations who are on reduced caloric diets and/or who cannot digest sugars, artificial sweeteners, or other sweeteners that add calories to the diet.

People often customize the taste of food and beverages by adding sweeteners. For example, tabletop sweeteners are routinely added to hot and cold beverages, such as, coffee, tea, and iced tea; on cereals; on fruit, and as toppings on baked goods and for cooking. Sweetening a food or beverage with a tabletop sweetener alters its taste and can increase its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that same amount of sweetness excessive. Moreover, consumers often desire to reduce their caloric intake for health or lifestyle reasons. Therefore, there exists a long-felt need for tabletop sweetener products that consumers may use to increase the sweetness of a product at the time of consumption that are consistent with their personal preferences, and yet minimize additional caloric burden. There is also a need for naturally sweetened foods, beverages, and orally administered pharmaceuticals, nutritional or dietary supplements, and herbal product alternatives that have minimal or reduced caloric implications.

Tabletop sweeteners are the primary vehicle by which such taste customization is accomplished. Tabletop sweeteners are presently available in many different forms, including powders, granular powder, tablets, liquids, cohesive non-free flowing compositions (e.g., cubes), and the like.

Many types of sweeteners are available as tabletop sweeteners. The most common sweeteners are nutritive sweeteners. These include sweeteners such as sucrose (e.g., cane sugar), honey, high fructose corn syrup, molasses, maple syrup, brown rice syrup, fruit juice sweeteners, barley malt, and the like, and artificial sweeteners, such as, sucralose, aspartame, saccharine, and the like. These are high calorie, high carbohydrate sweeteners and thus, unfit for some dieters, diabetics, and all others mindful of their caloric and sugar intakes.

Sugar alcohols are another form of sweetener. Often the makers or users of sugar alcohol sweeteners add other components to them to overcome a less pleasant taste, such as the bright taste associated with sugar alcohols like erythritol. Erythritol, for example, has a strong cooling effect (i.e., negative heat of solution), which is often described as “brightness” when it dissolves in water. While this effect may be appropriate in some confectionary applications, erythritol by itself is not considered ideal as a tabletop sweetener.

High intensity sweeteners are alternatives to nutritive sweeteners. High intensity sweeteners provide sweetness without the calories and other metabolic impacts of nutritive sweeteners. In many cases, high intensity sweeteners provide a sweetness that is preferred over nutritive sweeteners, but they are synthetic and not natural. Some high intensity sweeteners, such as aspartame, are also nutritive, but are intense. Other high intensity sweeteners, such as sucralose, are not absorbed when ingested and therefore are non-nutritive sweeteners.

Although high intensity sugar substitutes provide a greater sweetening effect than comparable amounts of caloric tabletop sweeteners, they typically have a taste profile that differs from sucrose or fructose such as increased astringency, bitterness, various aftertastes, delayed onset of sweetness, and they yield a different mouth feel. Sugar substitutes are often formulated with other materials (e.g., combinations of dextrins, polyols, amino acids) to achieve a taste profile to be more similar to that of sucrose or fructose. Nevertheless, consumers can still generally distinguish these sugar substitute formulations from caloric tabletop sweeteners. Therefore, formulations of natural, low or no-calorie tabletop sweeteners must be continually improved to meet consumer demand for sugar substitutes that also reasonably approximate the taste profile, texture, and mouth feel of caloric tabletop sweeteners.

Stevia is an all natural, high intensity, and zero calorie sweetener extracted from the plant Stevia rebaudiana bertoni. The plant makes a number of sweet compounds collectively referred to as steviol glycosides, which makes Stevia 300 times sweeter than sucrose. However, there is an aftertaste due to Sterebins (i.e., Sterebins A, B, C, D and E-N) and other steviol glycoside impurities. This aftertaste, described by many as bitter and licorice like, is present in all currently marketed Stevia extracts and/or Stevia containing products. Of the glycosides found in Stevia extracts, Rebaudioside A is known to have the least bitter aftertaste. While Stevia extracts have many excellent properties, improvements in their taste profile are highly desirable to be able to take advantage of its “sweetener” properties.

For the foregoing reasons, a need persists for all natural sweetener compositions having minimal bitterness and zero to low calories and carbohydrates, and zero to low glycemic index for use in orally administered pharmaceuticals, food, beverage, and other orally administered products, and for methods to make the same.

### SUMMARY

The present invention is directed to all natural sweetener compositions having minimal bitterness and zero to low calories and carbohydrates, for use in food, beverage, pharmaceutical, nutritional and other orally administered products, and to methods to manufacture the same.

Natural sweetener compositions having features of the present invention comprise a purified Stevia extract and at least one bulking agent, such as sugar alcohols, disaccharides, and monosaccharides. These compositions may also comprise one or more binders, flavorants, nutritional ingredients, aroma components, and combinations thereof. The purified Stevia extract comprises a pure primary steviol glycoside, i.e., rebaudioside A, stevioside, or glucosyl stevioside, each comprising 80 to 99.5 percent of the total weight of all steviol glycosides.

Naturally sweetened orally administered products, prepared by and having features of the present invention, comprise the step of mixing a natural sweetener composition having features of the present invention, in a concentration amount to sweeten said orally administered products, with other ingredients commonly used to manufacture said orally administered products.

Processes for the preparation of natural sweetener compositions, having features of the present invention, comprises the step of preparing a sweetener combination by combining a purified Stevia extract, which comprises a pure primary steviol glycoside, with at least one bulking agent, and optionally, with one or more additional ingredients. The processes further comprise amalgamating and sieving the sweetener combinations.

These and other features, aspects, and advantages of the present invention will become better understood with reference to the following description and examples.

### DESCRIPTION

### Definitions

Unless otherwise defined, all technical and scientific terms used herein have the same meaning as commonly understood by one of ordinary skill in the art to which the invention belongs. In case of any direct conflict, the present specification, including definitions, controls.

Although methods and materials similar or equivalent to those described herein can be used in the practice or testing of the present invention, suitable methods and materials are described herein. Such suitable methods and materials are provided as examples, however, and are not intended to restrict the scope of any claim or claim term.

Unless stated otherwise, all percentages, parts, ratios, etc. are by weight.

When an amount, concentration, or other value or parameter is given as a range, or as a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range. When the term “about” is used in describing a value or an endpoint of a range, the invention should be understood to include the specific value or endpoint referred to.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited only to the recited elements, but can include other elements not expressly recited or inherent to such process, method, article, or apparatus. Further, unless expressly stated to the contrary, “or” refers to an inclusive or, and not to an exclusive or. For example, a condition A or B is satisfied by any one of the following: A is true (or present) and B is false (or not present); A is false (or not present) and B is true (or present); and both A and B are true (or are present).

The use of “a” or “an” to describe the various elements or components herein is merely for convenience and to give a general sense of the invention. This description should be read to include one or at least one, and the singular also includes the plural unless it is obvious that it is meant otherwise.

The materials, methods, examples, and figures described herein are provided for illustrative purposes only and, except as specifically stated, are not intended to limit the scope of any claim or claim term. The scope of the invention is to be defined only by the language of the recited claims.

As used herein, the term “bulking agent” means an ingredient that (1) is sweet tasting (a co-sweetening agent), (2) possibly masks the bitter and/or aftertaste of Stevia extract and (3) allows for dispensing of natural sweetener compositions disclosed herein in manageable quantities.

As used herein, “calorie” refers to the unit of energy commonly appearing on the packaging of food and/or beverage items sold in the United States.

As used herein, “detectable amount” refers to the amount of the aroma component required to produce a scent detectable in a beverage, food and other orally administered products.

As used herein, a “food-grade” material is one that conforms to the standards for foods deemed safe for human consumption set forth in the Codex Alimentarius produced by the World Health Organization (1999).

As used herein, a “full-calorie” beverage formulation is one fully sweetened with a nutritive sweetener. The term “nutritive sweetener” refers generally to sweeteners which provide significant caloric content in typical usage amounts, e.g., more than about 5 calories per 8 oz. serving of beverage.

As used herein, “Generally Regarded as Safe (GRAS)” refers to a food ingredient that has been approved for use in foods, beverages, and/or pharmaceutical products by the Food and Drug Administration (FDA) of the United States of America.

As used herein, the term “high intensity sweetener” means a substance that provides a high sweetness per unit mass compared to a nutritive sweetener and provides little or no nutritive value. Examples of high intensity sweeteners include, for example, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, extracts of sweet plants, such as Stevia, thaumatin, salts, and combinations thereof. Several high intensity Stevia-based sweeteners are used in the present invention.

As used herein, the term “High Purity Glucosyl Stevioside” means the steviol glycoside of glucosyl stevioside having a purity of between 80 wt % to 99.5 wt % based on the total weight and a steviol glycoside impurity level of less than or equal to 3 wt % and a sterebin impurity level of less than or equal to about 0.5 wt %.

As used herein, the term “High Purity Reb A” means the steviol glycoside of rebaudioside A having a purity of between 80 wt % to 99.5 wt % based on the total weight of steviol glycosides and a steviol glycoside impurity level of less than or equal to 3 wt % and a sterebin impurity level of less than or equal to about 0.5 wt %.

As used herein, the term “High Purity Stevioside” means the steviol glycoside of stevioside having a purity of between 80 wt % to 99.5 wt % based on the total weight and a steviol glycoside impurity level of less than or equal to 3 wt % and a sterebin impurity level of less than or equal to about 0.5 wt %.

As used herein, the term “layer” may or may not refer to a material that entirely surrounds the underlying material.

As used herein, a “low-calorie sweetener” has fewer than 40 calories per 8 oz. serving of beverage.

As used herein, a “non-nutritive sweetener” is one which does not provide significant caloric content in typical usage amounts, e.g., one which imparts less than 5 calories to 8 oz. serving of beverage to achieve the sweetness equivalent of 2 teaspoons of sugar.

As used herein, the term “orally administered product” means any product for oral consumption by humans and animals for which its taste can be modified or masked.

As used herein, the term “pharmaceutical product” means orally administered human pharmaceutical and veterinary drug products. These such products include but are not limited to oral solid, dissolving solid and liquid dosage forms, such as chewing gums, chewable tablets or caplets, and lozenges; orally dissolving tablets, caplets or films, and cough and cold syrups, oral solutions, oral sprays, and oral liquid suspensions. These products are for consumption by geriatric and pediatric populations on low-calorie diets as well as diabetics.

As used herein, a “potent or high intensity sweetener” means a sweetener which is at least twice as sweet as sugar, i.e., a sweetener which on a weight basis requires no more than half the weight of sugar to achieve an equivalent sweetness. For example, a potent sweetener may require less than one-half the weight of sugar to achieve an equivalent sweetness in a beverage sweetened to a level equivalent to 2 teaspoons of sugar. Potent sweeteners include both nutritive (e.g., Lo Han Guo juice concentrate) and non-nutritive sweeteners (e.g., typically, Lo Han Guo powder). In addition, potent sweeteners include both natural potent sweeteners (e.g., steviol glycosides, Lo Han Guo, etc.) and artificial potent sweeteners (e.g., neotame, etc.). Commonly accepted potency figures for certain potent sweeteners are shown in Table 1 and include, for example, Cyclamate that is 30 times as sweet as sugar; Stevioside that is 100 to 250 times as sweet as sugar; Mogroside V that is 100 to 300 times as sweet as sugar; Rebaudioside A that is 150 to 300 times as sweet as sugar; Acesulfame-K that is 200 times as sweet as sugar; Aspertame that is 200 times as sweet as sugar; Saccharine that is 300 times as sweet as sugar; Neohesperidin dihydrochalcone that is 300 times as sweet as sugar; Sucralose that is 600 times as sweet as sugar; and Neotame that is 8,000 times as sweet as sugar.

TABLE 1
Comparison of potent or high intensity sweeteners

| | High Intensity Sweeteners | | |
|---|---|---|---|
| | | | Approved in US |
| | Natural or | Times Sweeter | as Table Top |
| Sweetener | Synthetic | than Sugar | Sweeteners |
| Cyclamate | Synthetic | 30 | No, banned |
| Stevioside | Natural | 100-250 | No |
| Glucosyl stevioside | Synthetic | 100-300 | No |
| Mogroside V | Natural | 100-300 | No |
| Rebaudioside A (>95%) | Natural | 100-400 | Yes |
| Acesulfame-K | Synthetic | 200 | No |
| Aspartame | Synthetic | 200 | Yes |
| Saccharine | Synthetic | 300 | Yes |
| Neohesperidin | Synthetic | 300 | No |
| dihydrochalcone | | | |
| Sucralose | Synthetic | 600 | Yes |
| Neotame | Synthetic | 8,000 | No |

As used herein, the term “primary steviol glycoside” means sweet constituent steviol glycosides found in the leaves of Stevia plants, such as rebaudioside A, stevioside, and glucosyl stevioside.

As used herein, the term “pure primary steviol glycoside” means the steviol gylcosides of each of rebaudioside A, stevioside, and glucosyl stevioside, each comprising 80 to 99.5 percent of the total weight of all steviol glycosides.

As used herein, the term “Pure Glucosyl Stevioside” means the steviol glycoside of glucosyl stevioside comprises at least about 80 percent of the total weight of all steviol glycosides.

As used herein, the term “Pure Reb A” means the steviol glycoside of rebaudioside A comprises at least about 80 percent of the total weight of all steviol glycosides.

As used herein, the term “Pure Stevioside” means the steviol glycoside of stevioside comprises at least about 80 percent of the total weight of all steviol glycosides.

As used herein, the term “purified Stevia extract” means a Stevia extract comprising sweet and non-sweet constituents, i.e., a pure primary steviol glycoside (that is, rebaudioside A, stevioside, or glucosyl stevioside) having a purity of at least greater than 80%, other steviol glycosides, and sterebins.

As used herein, “purity” means the amount of Reb A, stevioside or glucosyl stevioside contained in a pure or high purity Stevia extract based on the total weight of all steviol glycosides.

As used herein, a gram (or other given amount) of Sucrose Equivalent Sweetness (“SES”) means the amount of high intensity sweetener needed to be added to an 8 ounce glass of water in order to provide the same sweetness as an independent 8 ounce glass of water containing one gram (or the other given amount) of sucrose. For example, 1/200 g of aspartame will equal about one gram of SES because aspartame is about 200 times sweeter than sucrose. Similarly, about 1/500 g to about 1/600 g of sucralose will provide one gram of SES because sucralose is about 500 to about 600 times sweeter than sucrose.

As used herein, “taste” refers to a combination of organoleptic characteristics and perceptions such as sweet, bitter, salty, sour, metallic and other tastes, as well as temporal effects of perception, (e.g., on-set, duration, and off-tastes) residual perception (aftertaste) and tactile perception (e.g., body, thickness and mouth feel.)

As used herein, a “zero calorie sweetener” is less than 1 calorie per 1 gram weight of the sweetener composition.

### Overview

Natural sweetener compositions according to the present invention comprise a purified Stevia extract and at least one sugar alcohol. These compositions may also comprise one or more disaccharides, binders, flavorants, nutritional ingredients, aroma components, and combinations thereof.

To maximize the reduction in the bitter aftertaste of Stevia, one or more sugar alcohols, such as erythritol, are combined with a purified Stevia extract. Binders, such as lactose, further aid in the suppression of any potential bitterness in addition to facilitating the pressing and formation of tablets. Flavorants, nutritional ingredients, aroma components, and combinations thereof can also be added for aesthetic purposes.

Methods of making natural sweetener compositions comprise the steps of combining a purified Stevia extract with at least one sugar alcohol, such as erythritol and optionally, with a plurality of other ingredients and passing the resulting mixture through a particle sieve, or alternatively fluidizing and drying the resulting mixture and then passing it through a particle sieve.

Naturally sweetened orally administered products comprise natural sweetener compositions having a combination of purified Stevia extract, at least one sugar alcohol, and optionally, a plurality of other ingredients, in an amount to sweeten the orally administered product.

### Detailed Description of the Elements

### Stevia

At least certain exemplary embodiments of the natural sweetener compositions disclosed herein employ Stevia. Stevia is a non-caloric natural sweetener from the plant Stevia rebaudiana bertoni. The plant makes a number of sweet compounds collectively referred to as steviol glycosides, which make Stevia 300 times sweeter than sucrose. These glycosides can be extracted from the plant with water and other solvents. They are heat stable, pH stable, do not ferment, and do not induce a glycemic response.

Stevia is the extract of the native South American plant Stevia Rebaudiana Compositae Bertoni. The plant and extracts have been used for many years as a sweetener in South America and Asia. It also has a broad audience in the United States where it is sold as a dietary.

The leaves from the Stevia plant contain a complex mixture of natural sweet diterpene glycosides. Steviol glycosides, e.g., steviosides and rebaudiosides, are components of Stevia that contribute sweetness. Typically, these compounds are found to include stevioside (4-13% dry weight), steviolbioside (trace), the rebaudiosides, including rebaudioside A (2-4%), rebaudioside B (trace), rebaudioside C (1-2%), rebaudioside D (trace), and rebaudioside E (trace), and dulcoside A (0.4-0.7%). The following non-sweet constituents also have been identified in the leaves of Stevia plants: labdane, diterpene, triterpenes, sterols, flavonoids, volatile oil constituents, pigments, gums and inorganic matter.

The purity of steviol glycosides are based on high performance liquid chromatography (HPLC) analysis as specified in for example the Food Chemicals Codex Monograph 7 (FCC 7 monograph) based on the total steviol glycoside content as defined by the area percent of all steviol glycosides as listed in the following chromatographic profile table (i.e., Table 2).

TABLE 2
Steviol glycosides determined by HPLC analysis

| | Approx. Retention | Molecular |
|---|---|---|
| Compound | Time (Min) | weight |
| Rubusoside | 3.0 | 642.73 |
| Dulcoside | 3.9 | 788.87 |
| Stevioside | 4.5 | 804.88 |
| Rebaudioside C | 5.2 | 951.01 |
| Rebaudioside F | 5.6 | 936.99 |
| Rebaudioside A | 7.1 | 967.01 |
| Rebaudioside D | 16 | 1129.15 |
| Steviolbioside | 18 | 642.73 |
| Rebaudioside B | 36 | 804.88 |

HPLC purity determination can be determined by preparing a standard curve for the purified Stevia extract (either rebaudioside, stevioside or glucosyl stevioside) by plotting peak area vs. concentration (mg/l) using a pure standard (USP reference standard or other standard corrected for purity). The peak area of all other steviol glycosides are determined for the related steviol glycoside impurities in the chromatographic table (i.e., Table 2). Purity for the appropriate purified Stevia extract is based on the ratio of the purified Stevia extract to the other related steviol glycosides.

Stevioside, sometimes referred to as Stevia, (13-[(2-O-.beta.-D-glucopyranosyl)oxy]-kaur-16-en-18-oic acid-4.alpha.-.beta.-D-glucopyranosyl ester) and rebaudioside A (“Reb A”) are exemplary glycosides of the diterpene derivative steviol leaves. These glycosides are high intensity sweeteners, about 100 to about 500 times that of sucrose, but have metallic and bitter notes. They can be used in a wide range of low or reduced calorie food products and beverages. Other sweet glycosides can also be extracted from the Stevia plant and have varying degrees of sweetness such as glucosyl stevioside.

Glucosyl stevioside is an enzymatically modified Stevia stevioside and is produced for example after 20 hours reaction from dissolved mixtures of Stevia 90%, dextrin and enzymes. Glucosyl stevioside has the following characteristics: 1) is a light yellow to white powder, chip or granule, 2) has a sweetness 100-200 times that of sugar, 3) overcome the shortcomings of common stevioside with higher purity, and less bitterness or licorice aftertaste. Glucosyl stevioside has a sweet taste close to cane sugar. Glucosyl stevioside is stable under common food processing conditions (acidity and heat). It is soluble in water and alcohol. Glucosyl stevioside, is mainly used in low calorie food, soda pop, syrup, hot and iced drinks, cakes, and other food products.

Methods to selectively extract one or another of the glycosides have been previously disclosed.

In some forms, rebaudioside A may be produced synthetically. Rebaudioside A is conventionally obtained as an extract from portions of Stevia plants. In such extracted forms, the rebaudioside A may also contain amounts of other materials derived from the Stevia plant, such as, for example, steviol glycosides (including other steviol glycosides which may contribute to sweetness) and/or botanicals. Therefore, in some embodiments, such as those using rebaudioside A obtained from Stevia extracts, the rebaudioside A exists in a form that contains about 60% or more, or about 70% or more, or about 80% or more, or about 90% or more, or about 95% or more, or about 97% or more, or about 98% or more, by weight of rebaudioside A based on the total weight of the material.

### Distribution of Glycosides in Stevia Rebuadiana Leaves

Table 3 contains typical glycoside compositions in the Stevia plant leaves. As seen in Table 3 the principle steviol glycoside found in the Stevia plant is referred to as stevioside. Stevioside typically represents about 57% of the glycosides that are present in a Stevia extract.

TABLE 3
Comparison of the steviol glycosides contained in Stevia leaves

| | Concentration | | | % of |
|---|---|---|---|---|
| Steviol | in Leaves (%) | | | Glycosides |
| Glycoside | Low | High | Average | Average |
| Stevioside | 5 | 22 | 14 | 57 |
| Rebaudioside A | 1.5 | 10 | 6 | 24 |
| Rebaudioside B | 0 | 4 | 2 | 8 |
| Rebaudioside C | 0 | 4 | 2 | 8 |
| Rebaudioside D | 0 | 0.30 | 0 | 1 |
| Rebaudioside E | 0 | 0.30 | 0 | 1 |

Other glycosides found in the plant found in smaller quantities are noted in Table 3. Each has a different sweetness level and taste profile. Several grades of Stevia are available, better grades having a higher rebaudioside A level as they contribute to lower bitter taste levels.

Many products containing Stevia extracts are available in the United States marketplace. The Stevia extracts are generally blended with bulking ingredients to provide a manageable quantity for the user to dispense on whatever food product they wish to sweeten. For example, the Sweetleaf® sweetener product marketed by Wisdom Natural Brands® is bulked with maltodextrin or FOS. Truvia® and PureVia™ sweeteners contain Stevia extracts and high amounts of bulking agents provided in 3.5 gram and 2 gram packets, respectively, for sweetening beverages. Without a bulking agent, the amount of Stevia sweetener needed would be about 20 to about 25 mg or less because Stevia is about 300 times sweeter than sucrose. This amount is too small to reliably dispense from a sachet/packet or other typical sweetener package and require bulking agents. Bulking agents that can be used include sugar alcohols, such as erythritol or xylitol and disaccharides, such as lactose. As with other high intensity sweetener products, such as Splenda® or Equal®, the amount of bulking agent used is typically the smallest amount that provides for accurate delivery and acceptable taste. The sweetener compositions having features of the present invention are provided in 1 gram packets as a convenient zero calorie serving size. This efficient 1 gram sweetener serving size provides the sweetness equivalent to 2 teaspoons of sugar (8 gram serving size). The 1 gram serving size of the present invention is more efficient and provides sweetness to beverages and is an improvement over other Stevia-based sweeteners such as Truvia, PureVia and Sun Crystals which have larger serving sizes and higher calories provided in quantities of 3.5 grams, 2.0 grams and 1.3 grams, respectively.

### Purified Stevia Extract

At least certain exemplary embodiments of the natural sweetener compositions disclosed herein employ rebaudioside A, stevioside, glucosyl stevioside, and can include other steviol glycosides, or related compounds or mixtures of any of them for sweetening. These compositions, which include rebaudioside A or stevioside, can be obtained by extraction or the like from the Stevia plant.

The purified Stevia extract is a Stevia extract comprising: (1) a pure primary steviol glycoside, i.e., rebaudioside A, stevioside, or glucosyl stevioside; (2) other steviol glycosides, (3) and sterebins.

The pure primary steviol glycosides (i.e., rebaudioside A, stevioside, or glucosyl stevioside), comprise 80 to 99.5 percent of the total weight of all steviol glycosides, and are sweet constituents found in the leaves of Stevia plants. The other steviol glycosides and sterebins constitute less sweet components of Stevia, contribute to bitter after taste, and are considered impurities.

### Bulking Agents

### Sugar Alcohols

At least certain exemplary embodiments of the natural sweetener compositions disclosed herein employ sugar alcohols. A sugar alcohol is a food-grade alcohol derived from a sugar molecule.

Sugar alcohols vary in sweetness from about half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

Sugar alcohols include, for example, isomalt, erythritol, hydrogenated isomaltulose, hydrogenated starch hydrolyzates, lactitol, maltitol, mannitol, sorbitol, xylitol, and combinations thereof.

### Erythritol

Erythritol (butane-1,2,3,4-tetraol) is a natural, low calorie sweetener that has long been part of the human diet. It has a bright, sweet taste that is about 70% the sweetness of sucrose (i.e., cane sugar) on a weight basis. Erythritol contains less than 0.2 kcals per gram providing the equivalent of a teaspoon of sugar for around 1.2 kcals. While this is not as low as high intensity sweeteners like sucralose, which have no calories, it compares very favorable with sucrose (16 kcals/tsp), fructose (14 kcal/tsp SES), and tagatose (6.6 kcals/tsp SES).

Erythritol is absorbed into the bloodstream in the small intestine, and then for the most part, excreted unchanged in the urine. Because erythritol is normally absorbed before it enters the large intestine, it does not normally cause laxative effects as are often experienced after over-consumption of other sugar alcohols. Most people can consume erythritol with no side effects. This is important, as most other sugar alcohols are not absorbed directly by the body in this manner.

Erythritol masks bitter and metallic tastes from certain high intensity sweeteners, such Stevia extracts. Though the steviosides and rebaudiosides are very sweet (180-300 times sweeter than sucrose), they have metallic and bitter notes. Other sugar alcohols are sometimes utilized with erythritol, particularly isomalt, due to their minimally negative heat of solution. Glycerin, which has a positive heat of solution, moderate hygroscopicity, and non-crystallizing liquid form, has also been used.

### Xylitol

Similarly, xylitol can be a substitute for erythritol or can be used in combination with erythritol as a bulking agent to further minimize the bitter after taste of the pure Stevia extracts.

### Monosaccarides

At least certain exemplary embodiments of the natural sweetener compositions disclosed herein employ monosaccharides. Monosaccharides are the most basic units of biologically important carbohydrates. They are the simplest form of sugar and are usually colorless, water-soluble, crystalline solids. Monosaccharides are the building blocks of disaccharides such as sucrose and polysaccharides (e.g., cellulose and starch). Further, each carbon atom that supports a hydroxyl group (except for the first and last) is chiral, giving rise to a number of isomeric forms all with the same chemical formula. For instance, galactose and glucose are both aldohexoses, but have different chemical and physical properties. Some monosaccharides have a sweet taste. Examples of monosaccharides include glucose (dextrose), fructose (levulose), galactose, xylose and ribose.

### Disaccharides

At least certain exemplary embodiments of the natural sweetener compositions disclosed herein employ disaccharides. Disaccharides are carbohydrates formed when two monosaccharides undergo a condensation reaction which involves the elimination of a small molecule, such as water, from the functional groups only. Disaccharides dissolve in water, taste sweet and are called sugars. Disaccharides include, for example, maltose, lactose, sucrose, isomaltulose, maltulose, isomaltose, cellobiose, and combinations thereof.

### Lactose

Lactose is a caloric sugar that is found most notably in milk. Lactose makes up around 2-8% of milk (by weight), although the amount varies among species and individuals. It is extracted from sweet or sour whey. Sugars such as lactose have several important roles in foods.

For example, they provide sweetness. Besides improving the taste of foods, they improve the texture and color of baked goods.

Lactose is a disaccharide, has a formula of C12H22O11, and consists of galactose and glucose fragments bonded through a β-1→4 glycosidic linkage. Its systematic name is β-D-galactopyranosyl-(1→4)-D-glucose. The glucose fragment can be in either the α-pyranose form or the β-pyranose form, whereas the galactose fragment can only have the β-pyranose form: hence α-lactose and (β-lactose refer to anomeric form of the glucopyranose ring alone. Lactose has only about 20% of the sweetness as sugar and is used as a bulking agent in many high intensity sweeteners.

Lactose in either food grade or USP grade, is readily available through commercial sources. It has been estimated that the annual worldwide availability of lactose as a by-product of the dairy industry is several million tons. Whey contains about 4.8% of lactose, which may be purified by crystallization. Food industry applications, both of pure lactose and lactose-containing dairy by-products, have markedly increased since the 1960s. For example, its bland flavor has lent to its use as a carrier and stabilizer of aromas and pharmaceutical products.

### Additives

### Binders

At least certain exemplary embodiments of the natural sweetener compositions disclosed herein employ binders. A binder is any food-grade material that is suitable for facilitating the pressing and formation of tablets. The selection of an appropriate binder is not critical and embraces any conventional binder so long as the binder does not substantially interfere with the self-mixing or the organoleptic properties of the beverage, food or pharmaceutical dosage form. Binders include but are not limited to dextrose, gelatin, gum tragacanth, lactose, leucine, and combinations thereof.

### Flavorants

At least certain exemplary embodiments of the natural sweetener compositions disclosed herein employ flavorants. A flavorant is any food-grade material that may be added to the present compositions to provide a desired flavor to a beverage, food or other orally administered products. Flavorants include, but are not limited to, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

### Nutritional Ingredients

At least certain exemplary embodiments of the natural sweetener compositions disclosed herein employ nutritional ingredients.

Nutritional ingredients may be added to the present compositions and are ingredients that can help prevent diseases and promote health. There are seven categories of nutrients (dietary or nutritional ingredients) that the body needs to acquire from food—proteins, carbohydrates, fats, fibers, vitamins, minerals and water. Such dietary or nutritional ingredients, sweetened with natural sweetener compositions disclosed herein, can be used for a variety of health issues including but not limited to allergies, anemia, arthritis, colds, depressions, fatigue, gastrointestinal disorders, high or low blood pressure, insomnia, headaches, obesity, pregnancy, premenstrual syndrome, respiratory conditions, stress, and several other conditions.

Nutritional ingredients comprise proteins, carbohydrates, fats, fibers, vitamins, minerals, water, fruit extracts, anti-oxidants including lycopene, essential fatty acids including omega-3-fatty acids, fiber including oat bran, prebiotics, probiotics, dry fruits, and herbs.

Nutritional supplements include but are not limited to medicinal herbs, vitamins, mineral supplements, amino acids, green foods, fish oil supplements, and any other dietary supplements.

Herbal supplements include but are not limited to ginger, orange extract, ginseng powder, bilberries, gingko, kelp, avena sativa, kava, turmeric, senna, and combinations thereof.

### Aroma Components

At least certain exemplary embodiments of the natural sweetener compositions disclosed herein employ aroma components. Aroma components may be added to the present compositions and are any food-grade volatile substance that may be employed to produce a desired scent, for example, when mixed with a beverage, food or other orally administered products. Aromas include but are not limited to, essential oils (citrus oil); expressed oils (orange oil); distilled oils (rose oil); extracts (fruits); anethole (liquorice, anise seed, ouzo, fennel); anisole (anise seed); benzaldehyde (marzipan, almond); benzyl alcohol (marzipan, almond); camphor (cinnamomum camphora); cinnamaldehyde (cinnamon); citral (citronella oil, lemon oil); d-limonene (orange); ethyl butanoate (pineapple); eugenol (clove oil); furaneol (strawberry); furfural (caramel); linalool (coriander, rose wood); menthol (peppermint); methyl butanoate (apple, pineapple); methyl salicylate (oil of wintergreen); neral (orange flowers); nerolin (orange flowers); pentyl butanoate (pear, apricot); pentyl pentanoate (apple, pineapple); sotolon (maple syrup, curry, fennugreek); strawberry ketone (strawberry); substituted pyrazines (e.g., 2-ethoxy-3-isopropylpyrazine; 2-methoxy-3-sec-butylpyrazine, and 2-methoxy-3-methylpyrazine (toasted seeds of fenugreek, cumin, and coriander)); thujone (juniper, common sage, Nootka cypress, and wormwood); thymol (camphor-like); trimethylamine (fish); vanillin (vanilla); and combinations thereof.

### How the Invention is Used

Natural sweetener compositions having features of the present invention are suitable for use as an ingredient in orally administered products, e.g., as a sweetener, flavor enhancer, and flavor modifier in human and veterinary pharmaceutical (orally administered) dosage forms; beverages including smoothies, slushes, and alcoholic beverages; hot beverages including tea, coffee and other hot drinks; confectionaries; foods; dietary or nutritional supplements; herbal supplements, vitamin supplements; fruit extract supplements, and foods such as nutritional bars and the like.

Natural sweetener compositions having features of the present invention are also suitable for use as an ingredient in orally administered human and veterinary pharmaceutical dosage forms to provide an acceptable level of sweetness in the pharmaceutical dosage form without offering any calories in syrups, solutions, extracts, solid melt tablets, etc., specifically in drug products (cough and cold mixtures sweetened with sugar, sucralose, etc.) used by diabetics or people on reduced caloric intake.

Natural sweetener compositions having features of the present invention are also suitable for use as a natural pharmaceutical ingredient with zero caloric value, especially for formulation pharmaceutical dosage forms for diabetics, elderly patients on reduced caloric diets, dieters, pediatric populations that cannot digest sugars and artificial sweetener, or in pharmaceutical dosage forms including orally dissolving tablets and films, chewing gums, pharmaceutical solutions and suspensions, chewable tablets, oral sprays and the like.

Natural sweetener compositions having features of the present invention are most importantly suitable for use as a natural ingredient with zero caloric value, especially for formulation of herbal products and nutritional supplements for all populations specifically diabetics, elderly patients on reduced caloric diets, dieters, pediatric populations that cannot digest sugars and artificial sweetener. Such herbal and nutritional supplement products may include orally dissolving tablets and films, chewing gums, pharmaceutical solutions and suspensions, chewable tablets, immediate and extended release tablets, oral syrups and mouth sprays and the like.

Natural sweetener compositions having features of the present invention are also suitable for use as a natural ingredient with zero caloric value, especially for formulation of tea and coffee products, herbal tea and coffee products that are presweetened with sweetener compositions, and available as ready to use tea bags or coffee bags or commercial quantities of teas and coffees.

Natural sweetener compositions having features of the present invention are also suitable for use as a natural sweetener ingredient to be added to prepared beverages including hot beverages including coffee, tea, ciders, and cold beverages including iced coffee, iced tea, cold ciders, hot or Chocolate or cocoa, lemonade, water, soft drinks, juices, slushes, milk shakes and smoothies, and alcoholic beverages including margaritas, daiquiris, fruit sangrias, and mojitos and the like.

Orally administered products sweetened using natural sweetener compositions having features of the present invention include but are not limited to foods (such as baked goods, confectionaries, cereals, cookies, puddings, spices, marinades, sauces, nutritional bars, pies, cakes, fruits, breakfast dishes and desserts); unsweetened, presweetened, alcoholic and non-alcoholic beverages (such as coffee, iced coffee, iced tea, tea, herbal teas, ready to use tea and coffee bags, commercial quantities of teas and coffees, ciders, chocolate or cocoa, lemonade, water, soft drinks, juices, slushes, milk shakes smoothies, margaritas, daiquiris, fruit sangrias, mojitos and the like); nutritional supplements (including herbal products, dietary or nutritional supplements, vitamin supplements, and fruit extract supplements); pharmaceutical products (such as pharmaceutical dosage forms including orally dissolving tablets and films, chewing gums, pharmaceutical solutions and suspensions, chewable tablets, oral sprays, capsules, liquid melts, gums, lozenges, cough syrups, powders for reconstitution, powders for ingestion); and veterinary products (such as food, medication and other health supplies for animals.)

Natural sweetener compositions having features of the present invention comprise purified Stevia extracts, whereby the rebaudioside A or stevioside or glucosyl stevioside levels are higher than about 80 percent by weight relative to all steviol glycosides (Rebaudioside B, C, D and E). Further, purer primary steviol glycosides have levels of about 90 percent by weight relative to all steviol glycosides. Primary steviol glycosides having levels of about 95 percent by weight relative to all steviol glycosides render them even more pure.

Natural sweetener compositions having features of the present invention, used in a ratio of between 1 gram to between 20 ml to 1000 ml of a beverage or between 0.1 to 5% w/v, provides an acceptable level of sweetness. Further, natural sweetener compositions having features of the present invention, used in a ratio of between 1 gram to between 50 ml to 500 ml of a beverage or between 0.2 to 2% w/v, greater provides an acceptable level of sweetness.

Natural sweetener compositions having features of the present invention, used in a ratio of between 1 gram to between 20 g to 1000 g of a food or 0.1 to 5% w/w, provides an acceptable level of sweetness. Further, natural sweetener compositions having features of the present invention, used in a ratio of between 1 gram to between 50 g to 500 g of a food, or 0.2 to 2% w/w, greater provides an acceptable level of sweetness.

Natural sweetener compositions having features of the present invention are heat stable for use in baking foods at temperatures of up to approximately 400° F.

Natural sweetener compositions having features of the present invention, used in a ratio of between 1 mg to between 20 mg to 1000 mg or between 5% w/w to 0.1% w/w, respectively, of a solid oral pharmaceutical product, nutritional product or vitamin supplement, such as a buccal tablet, orally dissolving film, lozenge, chewing gum, etc., provides an acceptable level of sweetness. Further, natural sweetener compositions having features of the present invention, used in a ratio of between 1 gram to between 50 mg to 500 mg or between 2% w/w to 0.2% w/w, respectively, of a solid oral pharmaceutical product, nutritional product or vitamin supplement, such as a buccal tablet, orally dissolving film, lozenge, chewing gum, etc., provides an acceptable level of sweetness.

Natural sweetener compositions having features of the present invention, used in a ratio of between 1 gram to between 20 ml to 1000 ml or between 5% w/v to 0.1% w/v, respectively, of a liquid oral pharmaceutical product, nutritional product or vitamin supplement, such as an oral solution, oral spray, and oral liquid suspension, provides an acceptable level of sweetness.

Further, natural sweetener compositions having features of the present invention, used in a ratio of between 1 gram to between 50 ml to 500 ml or between 2% w/v to 0.2% w/v or greater, respectively, of a liquid pharmaceutical oral solution, oral spray, and oral liquid suspension, provides an acceptable level of sweetness.

### ADVANTAGES OF THE INVENTION

Natural sweetener compositions having features of the present invention offer superior and far more efficient sweetening options. More importantly, they have zero to low calories and provide purer and higher sweetening with fewer additives. The combination of one or more sugar alcohols and/or disaccharides with amounts of purified Stevia extracts, as the natural sweetener compositions having features of the present invention provide, aids to mask the bitter taste normally associated with currently marketed Stevia products while maintaining its sweetness. The bitter aftertaste is further reduced by using a purified form of Stevia extracts. In addition to other additives, flavorants and aroma components, can be added for aesthetic purposes as well as binders to facilitate uniformity of dosage and production of appropriate sweetener products including tablets.

Natural sweetener compositions having features of the present invention yield a less bitter aftertaste compared to other Stevia based sweeteners. The sweetness and flavor is contributed by the combination of a purified Stevia extract plus one or more bulking agents such as sugar alcohols like erythritol. A reduction in bitter aftertaste results from the pure primary steviol glycoside of the purified Stevia extract, like, for example, rebaudioside A. More specifically in that example, the reduction in bitter aftertaste is due to the High Purity Reb A, i.e., the low content (less than or equal to about 0.5%) of the bitter sterebins (i.e., Sterebins A, B, C, D and E-N) and other bitter steviol glycoside impurities (stevioside, Rebaudioside A, C and Dulcoside), the combination of which is equal to about 3% or less.

Natural sweetener compositions having features of the present invention are suitable for use by many but especially by dieters, diabetics, or all other persons concerned about their caloric intake. These compositions are suitable as a natural ingredient in orally consumed and administered products, such as pharmaceutical products, nutritional and herbal supplements, foods, beverages, and veterinary products.

In typical embodiments, natural sweetener compositions having features of the present invention provide at least one, if not more, of the following desirable characteristics: (a) zero to fewer calories per gram than standard table sugar; (b) zero to fewer calories than an amount of standard table sugar perceived as providing comparable sweetness; and (c) lower glycemic index than that of standard table sugar. In some embodiments, the sweetener composition has less than about 5 calories/gram, or less than about 3 calories/gram, or less than about 1 calorie/gram. In a typical tabletop sweetener application, for example, the sweetener composition can be packaged in a form where it provides a similar sweetness equivalent to about 8 grams of sucrose while providing less than about 5 calories.

The processes for the preparation of natural sweetener compositions having features of the present invention impart a uniform coating that enhances the dissolution of the natural sweetener, and facilitate the compositions' uniformity, well-defined particle size and granularity for easy dispensing from packets, jars, canisters, etc.

### SPECIFIC EMBODIMENTS & EXAMPLES

The following examples provide illustrative embodiments of the inventions described and claimed herein. These examples are not intended to provide any limitation on the scope of the invented subject matter. The scope of the invention shall be limited only by the language of the claims. Further, it is not necessary for all embodiments of the invention to have all the advantages of the invention or fulfill all the purposes of the invention.

### Sweetener Compositions:

Natural sweetener compositions having features of the present invention comprise (a) a Stevia extract of high purity comprising rebaudioside A, stevioside or glucosyl stevioside, (b) one or more bulking agents comprising sugar alcohols, monosaccharides and/or disaccharides, (c) flavorants, (d) binders, (e) aroma components, (f) nutritional ingredients, and combinations thereof.

Natural sweetener compositions having features of the present invention comprise (a) a Stevia extract of high purity comprising rebaudioside A, stevioside or glucosyl stevioside, (b) one or more sugar alcohols, and optionally, (c) monosaccharides and/or disaccharides (d) flavorants, (e) binders, (f) aroma components, (g) nutritional ingredients, and combinations thereof.

Natural sweetener compositions having features of the present invention comprise a varying amount of the purified Stevia extract. The amount can be from about 0.5 to 10 percent by weight, or further, from about 1.5 to 5 percent by weight, or even further, from about 1 to 2.5 percent by weight, based on the total weight of the composition.

The amounts of the purified Stevia extract to get the reduction in bitter aftertaste can also be stated in a relational-ratio of erythritol. On a weight basis, the ratio is from about 200:1 to about 10:1, or further, from about 66:1 to about 20:1, or even further, from about 100:1 to about 40:1.

The purified Stevia extract of natural sweetener compositions having features of the present invention may consist of rebaudioside A. In some embodiments, the sweetener composition contains from about 0.5 percent by weight to about 10 percent by weight, or from about 0.7 percent by weight to about 5.0 percent by weight, or from about 1.0 percent by weight to about 2.5 percent by weight of rebaudioside A, based on the total weight of the resulting composition. In some embodiments, the sweetener composition contains about 1.0 percent by weight of rebaudioside A, based on the total weight of the resulting composition. In another embodiment, the sweetener contains about 2.0 percent by weight of rebaudioside A, based on the total weight of the resulting composition. The amount of rebaudioside A used will in certain situations depend on the purity of the material. Thus, where the rebaudioside is in the form of, for example, a Stevia plant extract containing about 80% by weight rebaudioside A, more of the extract may be desirable to achieve the desired result.

The purified Stevia extract of natural sweetener compositions having features of the present invention may consist of stevioside. In some embodiments, the sweetener composition contains from about 0.5 percent by weight to about 10 percent by weight, or from about 0.7 percent by weight to about 5.0 percent by weight, or from about 1.0 percent by weight to about 2.5 percent by weight of stevioside, based on the total weight of the resulting composition. In some embodiments, the sweetener composition contains about 1.0 percent by weight of stevioside, based on the total weight of the resulting composition. In another embodiment, the sweetener contains about 2.0 percent by weight of stevioside, based on the total weight of the resulting composition. The amount of stevioside used will in certain situations depend on the purity of the material. Thus, where the stevioside is in the form of, for example, a Stevia plant extract containing about 80% by weight stevioside, more of the extract may be desirable to achieve the desired result.

The purified Stevia extract of natural sweetener compositions having features of the present invention may consist of glucosyl stevioside. In some embodiments, the sweetener composition contains from about 0.5 percent by weight to about 10 percent by weight, or from about 0.7 percent by weight to about 5.0 percent by weight, or from about 1.0 percent by weight to about 2.5 percent by weight of glucosyl stevioside, based on the total weight of the resulting composition. In some embodiments, the sweetener composition contains about 1.0 percent by weight of glucosyl stevioside, based on the total weight of the resulting composition. In another embodiment, the sweetener contains about 2.0 percent by weight of glucosyl stevioside, based on the total weight of the resulting composition. The amount of glucosyl stevioside used will in certain situations depend on the purity of the material. Thus, where the glucosyl stevioside is in the form of, for example, a Stevia plant extract containing about 80% by weight stevioside, more of the extract may be desirable to achieve the desired result.

Natural sweetener compositions having features of the present invention comprise one or more sugar alcohols, or alternatively, one or more monosaccharides or disaccharides. In some embodiments, the sweetener composition contains from about 40 percent by weight to about 99.5 percent by weight, or from about 50 percent by weight to about 99 percent by weight, of one or more sugar alcohols or one or more disaccharides, based on the total weight of the resulting composition. In other embodiments, the sweetener composition contains from about 60 percent by weight to about 99 percent by weight, or from about 80 percent by weight to about 98 percent by weight, of one or more sugar alcohols or one or more disaccharides, based on the total weight of the resulting composition. Particular natural sweetener compositions having features of the present invention contain erythritol, xylitol, mannitol, sorbitol, or lactose, while others contain arabitol, dulcitol, glycerol, hydrogenated isomaltulose, hydrogenated starch hydrolyzates, iditol, isomalt, lactitol, maltitol, polyglycitol, ribitol, threitol, maltose, sucrose, isomaltulose, maltulose, isomaltose, cellobiose and combinations thereof.

Natural sweetener compositions having features of the present invention may also comprise varying amounts of disaccharides and/or monosaccharides, other sugar alcohols, honey, or evaporated cane juice, and rebaudioside A. The desired amount of each substance may vary depending on, among other factors, the desired use of the sweetener composition, the presence or absence of other components in the sweetener composition, the identity of any disaccharide, if present, and the presence or absence of a monosaccharide. Particular natural sweetener compositions having features of the present invention contain lactose while other contain other disaccharides like maltose, lactose, sucrose, isomaltulose, maltulose, isomaltose, cellobiose, and combinations thereof. Some compositions contain monosaccharides such as glucose, galactose, xylose and ribose.

The binder, if used, accounts for about up to 5%, by weight of the total composition. Particular natural sweetener compositions having features of the present invention contain lactose while others contain dextrose, gelatin, gum tragacanth, and combinations thereof.

Natural sweetener compositions having features of the present invention may also comprise varying amounts of flavorants, nutritional ingredients, and aroma components. Particular natural sweetener compositions having features of the present invention contain citric acid or tartaric acid. Particular natural sweetener compositions having features of the present invention also contain proteins, carbohydrates, fats, fibers, vitamins, minerals, water, fruit extracts, anti-oxidants, essential fatty acids, fiber, prebiotics, probiotics, dry fruits and herbs.

The aroma component, if present, can be present in an amount from about 2- to about 10-times the detectable amount. Further, the aroma component can be present in an amount from about 2- to about 5-times the detectable amount.

In some embodiments, natural sweetener compositions having features of the present invention contain (a) from about 60 percent by weight to about 99 percent by weight of lactose; (b) about 0.5 percent by weight to about 10 percent by weight rebaudioside A or stevioside or glucosyl stevioside; and optionally, (c) one or more other disaccharides, (d) a flavorant, (e) binder, (f) aroma component and combinations thereof.

Natural sweetener compositions having features of the present invention may also comprise amounts of other ingredients in addition to one or more bulking agents and rebaudioside A. Such additional ingredients include, but are not limited to, binders, sweetness modifiers, mouth feel enhancers, and flavorants (e.g., vanilla). As noted above, honey and/or evaporated cane juice may be used in place of or in combination with the erythritol. Natural flavorants and other ingredients are encouraged when the product is to be labeled as “all-natural.”

In some embodiments, natural sweetener compositions having features of the present invention contain a plurality of sweetener particles, where such particles contain one or more of the sweetening ingredients present in the sweetener composition. In some embodiments, the sweetener composition substantially comprises sweetener particles. In such embodiments, the sweetener composition contains at least about 80 percent by weight sweetener particles, or at least about 85 percent by weight sweetener particles, or at least about 90 percent by weight sweetener particles, based on the total weight of the resulting composition.

Sweetener particles, when present in the sweetener composition, can have any size suitable for use as a sweetener. In some embodiments, the average size of the sweetener particles is between about 50 microns and about 1250 microns, or between about 100 microns and about 1000 microns. Screening to eliminate particles of undesired sizes can be carried out during the manufacturing process. Thus, in some embodiments, the particle sizes, after screening to eliminate undesired large particles which may be as large as 1500 micron, may vary up to about 16 mesh, or from about 14 mesh, or from about 12 mesh, based on the standard United States sieve scale. Further, smaller particle sizes, e.g., about 50, 100, or 150 mesh, or even less than about 1 micron, may be present with the larger particles. Screening using a particle sieve to eliminate particles having sizes less than, for example, about 100 or 150 mesh can be carried out if desired. An ideal particle size range is between 40 to 60 mesh or between 250 to 400 microns, respectively.

Sweetener particles in the sweetener composition may or may not have uniform composition. Natural sweetener compositions having features of the present invention comprise rebaudioside A and an effective amount of a sugar alcohol or monosaccharide or disaccharide where the composition is a mixture of particles. More specifically, the mixture comprises (a) particles having a sugar alcohol, monosaccharide or disaccharide core coated with Reb A as well as other components, are predominantly coated on the particles. These coatings on the cores can be either a continuous phase or a discontinuous phase, i.e., where the different coating components form discrete regions in the core coatings.

Thus, in some embodiments, the sweetener composition contains (a) a plurality of first sweetener particles, where the first sweetener particles have (i) an erythritol core, (ii) a first erythritol core-coating layer comprising rebaudioside A and erythritol. Other embodiments may contain monosaccharides or disaccharides as the core or combinations of these with sugar alcohols. Other embodiments may contain pure Stevia extracts in combination with monosaccharides or disaccharides as the core coating layer or combinations of these with sugar alcohols.

In such embodiments, the core-coating layers may or may not have uniform composition, and may or may not substantially coat the underlying core or layer. These sweetener compositions may also contain flavorants (e.g., vanilla), mouth feel enhancers, and/or sweetness modifiers. When one or more of these are present, the first erythritol core-coating layer and/or the disaccharide core-coating layer may contain one or more of flavorants (e.g., vanilla), mouth feel enhancers, and/or sweetness modifiers. Thus, a “layer” may be non-uniform in composition and may provide only discontinuous coverage of the underlying material. Moreover, when one layer covers another, the boundary between the layers may or may not be discrete; thus, the boundary between layers may be continuous or semi-continuous.

In the sweetener compositions described in the previous paragraph, the sweetener compositions may or may not contain other particles in addition the plurality of first sweetener particles and the plurality of second sweetener particles. The first sweetener particles and the second sweetener particles may have any particle size that is suitable for use of the composition as a sweetener. In some embodiments, the average size of the first sweetener particles and second sweetener particles is between about 50 microns and about 1250 microns, or between about 100 microns and about 1000 microns. In some embodiments, the particle sizes of the first sweetener particles and the second sweetener particles, after screening to eliminate undesired large particles which may be as large as 1500 micron, will vary up to about 16 mesh, or about 14 mesh, or about 12 mesh based on the standard United States sieve scale. Further, smaller particle sizes, e.g., about 50, 100, or 150 mesh, or even less than about 1 micron, will be present with the larger particles. In some embodiments, the sweetener composition comprises a mixture of the plurality of first sweetener particles and the second sweetener particles. Such a mixture may or may not contain other types of particles.

The layers in the sweetener composition particles are generally not distinct, i.e., there is no clear distinction between the first layer and the second layer. For example, the first layer contains rebaudioside A, optional flavorants, etc., all encased in disaccharide; and the second layer will be predominantly disaccharide with some of the other components. The relative quantities of the various components in the layers, and whether there are layers in the particles, can be modified as necessary by adjusting when during the manufacturing process the components are added.

As noted above, in some embodiments of the invention, the sweetener composition comprises rebaudioside A and a taste-improving amount of xylitol as a mixture, where the mixture comprises (a) particles having an erythritol core and (b) particles having a disaccharide core. In some such embodiments, the disaccharide core comprises isomaltulose. Further, in some such embodiments, the erythritol core and/or the disaccharide core further comprise coating layers having discrete regions of rebaudioside A. When such coating layers are present, the coating layers may or may not substantially coat the underlying core material. These particles may have any particle size that is suitable for use of the composition as a sweetener. In some embodiments, the average size of the particles is between about 50 microns and about 1250 microns, or between about 100 microns and about 1000 microns. In some embodiments, the particle sizes of the particles range from about 16 mesh, or from about 14 mesh, or from about 12 mesh to about 100 mesh, based on the standard United States sieve scale.

Natural sweetener compositions having features of the present invention may have any dissolution rate in water that is suitable for their use as sweeteners. In some embodiments, the sweetener composition can have a dissolution rate in water at 10 degree C. of between about 100 seconds and about 200 seconds, or between about 125 seconds and about 175 seconds, or between about 140 seconds and 160 seconds, based on the dissolution of about 1 gram of the sweetener composition in 240 mL of water. In some embodiments, the sweetener composition can have a dissolution rate in water at 45 degree C. of between about 50 seconds and about 150 seconds, or between about 75 seconds and about 125 seconds, or between about 85 seconds and 110 seconds, based on the dissolution of about 1 grams of the sweetener composition in 240 mL of water. In some embodiments, the dissolution rate of the sweetener composition is about 150 seconds at 10 degree C. and about 96 seconds at 45 degree C. based on the dissolution of about 1 gram of the sweetener composition in 240 mL of stirred water. In some embodiments, the dissolution of 1 gram of sweetener in 240 mL of water at 25 degrees C. is about 20 to 60 seconds.

In certain embodiments, the invention provides a package containing a predetermined amount of from about 0.5 grams to about 3.5 grams of a solid sweetener composition, where the predetermined amount of the solid sweetener composition has a sweetness equivalent to about four times (by weight) the predetermined amount of sucrose, and where the solid sweetener composition comprises: (a) from about 80 percent by weight to about 99 percent by weight erythritol; and (b) from about 0.75 percent by weight to about 10 percent by weight rebaudioside A or stevioside or glucosyl stevioside.

In the packages containing a predetermined amount of the solid sweetener composition, the predetermined amount is about 1 gram and has a sweetness equivalent to about 4 grams of sucrose, or the predetermined amount is about 2 grams and has a sweetness equivalent to about 8 grams of sucrose.

Natural sweetener compositions having features of the present invention may have any bulk density that is suitable for their use as sweeteners. In some embodiments, the bulk density of the sweetener composition ranges from about 0.5 g/cm3 to about 1.0 g/cm3, or from about 0.7 g/cm.3 to about 0.8 g/cm3. In some embodiments, the bulk density of the sweetener composition is about 0.76 g/cm3.

### Uses of Sweetener Compositions:

The natural sweetener compositions having features of the present invention may be used to sweeten various types of beverages, foods, and any type of orally administered or ingested product(s). In some embodiments, the sweetener composition is used to sweeten a beverage by introducing the sweetener composition to a beverage. Suitable beverages include, but are not limited to, coffee, tea, tisane, carbonated beverages, juices, smoothies, sports drinks, protein shakes, frozen drinks, flavored drinks (e.g., lemonade), alcoholic beverages, and nutritional and dietary supplements. This introduction of the sweetener composition can occur at any time, for example, during the packaging (e.g., bottling) of the beverage or immediately prior to consumption.

In a similar manner, the sweetener compositions may also be introduced to various solid and liquid-based medicines, pharmaceutical products, and nutritional supplements, including both over-the-counter drugs, prescription drugs, and herbal supplements and products. In other embodiments, the sweetener composition is used to sweeten a solid (including semi-solid) food item by introducing the sweetener composition to a solid food item, a nutritional product, or a dietary supplement. Suitable solid food items include, but are not limited to, ice cream, pudding, gelatin food items, powdered mixes, fruit, cereal, candy, cookies, cakes, energy bars, and the like. This introduction of the sweetener composition can occur at any time, for example, during the preparation of the food item (e.g., introduction to cake or cookie batter) or immediately before consumption (e.g., introduction to fresh fruit or cold cereal).

### Products Containing Sweetener Compositions:

The invention provides a packaged sweetener formulation containing a sweetener composition of the invention. To yield a packaged sweetener formulation, the sweetener composition can be packaged in any manner known to those of skill in the art. In some embodiments, for example, the sweetener composition is introduced in a paper sachet or packet or paper stick, where the sachet or stick contains about 1 gram of sweetener composition that provides a comparable sweetness to about 8 grams or 2 teaspoons of table sugar. In other embodiments, the sweetener composition is introduced into a larger box, bag, or jar, canister with a sprinkle cap that is suitable for sale on a grocery store shelf. Other embodiments of such sweeteners may include tablets in a bottle or single tablet dispensing device. Other embodiments of the sweetener are provided in bulk containers of 5 to 50 kg.

Tablets or quick dissolving films having the sweetener composition of the invention may contain, for example, from about 25 mg to 1000 mg of the composition.

The invention also provides for food and beverage products containing a sweetener composition of the invention. Such products include both liquid and solid food items, such as those described above.

The invention also provides pharmaceutical formulations containing sweetener compositions of the invention. These pharmaceutical formulations include both over-the-counter and/or prescription medicines, and includes both liquid formulations and solid formulations (e.g., quick dissolve tablets and granules, chewable tablets, quick dissolving films, chewing or other gums, lozenges, syrups, suspensions, and solutions etc.)

### Processes for the Preparation of a Natural Sweetener Composition:

Compositions having features of the present invention can be made according to the following examples, or by any method known to those skilled in the art that provide homogenous even or homogeneous mixtures of the ingredients. These methods include dry blending, spray drying, agglomeration, wet granulation, compaction, and co-crystallization.

In one aspect, the invention provides a method of manufacturing a sweetener composition comprising: (a) providing a fluid-bed coating apparatus; (b) introducing dry erythritol to the fluid-bed coating apparatus; (c) charging substantially the dry ingredients in the fluid-bed coating apparatus; (d) spraying a coating solution of rebaudioside A dissolved in a suitable solvent into the fluid-bed to form coated sweetener particles; (e) drying the coated sweetener particles; and (f) sieving and filling the product into packets or other suitable containers.

The process may be carried out in any fluid-bed coating apparatus suitable for carrying out the process. In some embodiments, the method employs a bottom-spray (Wurster) fluid-bed coating apparatus. Other coating devices may be suitable, however, and may be selected according to the knowledge of one of skill in the art.

In some embodiments, it may be useful to preheat the fluid bed to lower the fluidizing air dew point, e.g., up to about 75 degree C. The introduction and charging of the dry ingredient(s) may occur by any means suitable for the selected fluid-bed coating apparatus.

A coating solution is sprayed into the fluid bed to form coated sweetener particles. In some embodiments, at least about 80 percent by weight, or at least about 90 percent by weight, or at least about 95 percent by weight, of the particles in the fluid bed are at least partially coated with the coating solution. During the spraying step, the fluidizing air rate in the fluid-bed coating apparatus is maintained so as to avoid excessive clumping of coated product, but also to avoid generation of excessive fines, thus reducing the yield of coated particles. A suitable fluidizing air rate will depend, at least in part, on the composition and particle size of the dry ingredients and on the configuration of the coating chamber. In addition, the spray rate of the rebaudioside A solution is maintained so as to achieve maximum coating with a minimum amount of clumping. A suitable spray rate will depend, at least in part, on the composition and particle size of the dry ingredients and on the configuration of the coating chamber. A suitable spray time will depend, at least in part, on the spray rate, the particle sizes, and the particle composition. In some embodiments, the spray time can range from about 3 minutes to about 15 minutes. The coating process may be carried out at any suitable temperature.

The coated sweetener particles are dried. In typical embodiments, the drying is conducted in the fluid-bed coating apparatus. In some embodiments, for example, the air temperature in the fluid bed could be increased up to about 125 degree C. to permit efficient drying of the coated particles. Other drying temperatures may be suitable, however, depending on the degree of coating, the rate of air flow, and the configuration of the fluid-bed coating apparatus.

In some embodiments, the dried coated particles undergo a screening process to remove excessively small and excessively large particles. The desired particle size will depend on the intended use of the sweetener composition. In some embodiments, for example, the dried coated particles are screened to remove substantially all particles smaller than about 100 mesh and substantially all particles larger than about 16 mesh, or larger than about 14 mesh, or larger than about 12 mesh (based on standard United States sieve scale). The screening may occur in any suitable screening apparatus.

In some embodiments, the process may include the addition of one of more sweetness modifiers, mouth feel enhancers, and/or flavorants (e.g., vanilla). In some such embodiments, one or more sweetness modifiers, mouth feel enhancers, and/or flavorants (e.g., vanilla) are added as dry ingredients and are introduced into the fluid-bed coating apparatus with the existing ingredients. In other such embodiments, one or more sweetness modifiers, mouth feel enhancers, and/or flavorants (e.g., vanilla) are added into the coating solution and sprayed onto the dry particles.

### Packaging:

The sweetening composition can be packaged in sachets or packets, dissolvable sweetening strips, sprays, drops, as a bulk sweetener, in cubes, or any normal sugar forms. Unit doses forms like sachets and cubes can contain from about 500 mg to about 10 g of SES. A composition of the present invention can deliver 5 mg to 50 mg of purified Stevia extract per unit package, or 10 mg to 25 mg of purified Stevia extract per unit package, or even 10 mg to 20 mg of purified Stevia extract per gram of package sweetener composition.

The sweetening composition of the present invention can be provided to consumers in any form suitable for delivery into the comestible to be sweetened, including sachets, packets, bulk bags or boxes, cubes, tablets, mists, drops, or dissolvable strips. The composition can be delivered as a unit dose or in bulk form.

The following examples are provided to further illustrate the compositions and methods of the present invention. These examples are illustrative only and are not intended to limit the scope of the invention in any way.

Compositions may contain between 0.5% and 5% of Pure Reb A and between 95 and 99.5% erythritol. Other compositions may contain between 0.5% and 5% of High Purity Reb A and between 95 and 99.5% erythritol.

For optimized sweetness, a sweetener composition may contain 2.0% of High Purity Reb A and 98% erythritol. The sweetener composition is then filled into 1 gram packets for use as a sweetener for hot and cold beverages, breakfast dishes, deserts and fruits. 1 gram of the improved sweetener composition is equivalent in sweetness to 2 teaspoons or 8 grams of sucrose.

The bulk sweetener can also be added and used in baking foods such as cookies, cakes and pies and the like. It can be used as a general confectionary with improved taste.

The bulk sweetener can be added to oral pharmaceutical dosage forms for taste making and sweetening applications as a zero calorie, no sodium, low carbohydrate, zero glycemic index natural sweetener. The pharmaceutical dosage forms include: liquids, sprays, solutions, suspensions, orally dissolvable forms such as films, wafers, tablets, chewable tablets, gums, and lozenges for sore throat and the like. The prescription and non-prescription pharmaceutical dosage forms may contain one or more drugs, nutraceuticals, vitamins, and the like.

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents. Unless otherwise defined, all technical and scientific terms used herein have the same meaning as commonly understood by one of ordinary skill in the art to which this invention pertains. All publications, patent applications, patents, and other references mentioned herein are incorporated by reference in their entirety. In case of conflict, the present specification, including definitions, will control.

### Example 1

The sweetener composition of Formulation No. 0 described in the Tables 4 and 5 is a free-flowing, crystalline granular powder and has a calculated sweetness equivalent value of 1.0 grams=8 grams sugar. It contains 1.8% of Pure Reb A 97% and 98.1% erythritol. The sweetener composition can be packaged into sachets or sticks as serving sizes of, for example, 1.0 gram.

TABLE 4
Composition of sweetener containing Pure Reb A and erythritol
(formulation No. 0)

| | Relative sweetness | | Sugar |
|---|---|---|---|
| Formulation | (times sweeter than | Quantity in | Equivalent |
| Number 0 | sugar) | milligrams | in grams |
| Erythritol | 0.70 | 982 | 0.69 |
| Reb A 97% | 400.00 | 18 | 7.20 |
| Total | | 1,000 | 7.89 |
| Two teaspoons of sugar | | | 8.00 |
| weight in grams | | | |

Note:
The supplier of Reb A 97% was Shandong Huaxian.

### Example 2

The sweetener compositions described in Table 5 are free-flowing, crystalline granular powders. The compositions of Formulation Nos. 0 to 10 contain Pure Reb A 97% (Shandong Huaxian and RioNatural) or High Purity Reb A 97% (Sweet Green Fields, SGF) in concentrations of 1.0, 1.5, 1.8, 2.0 and 2.5% formulated with either erythritol or lactose. Samples were prepared by weighing the appropriate quantity of each ingredient to prepare 10 grams and mixing with a spatula. 1 gram quantities of each formulation were then weighed and packaged into 1 gram quantities into polyethylene Ziplock pouches. The sweetener composition can also be packaged into sachets (packets) or sticks as serving sizes of, for example, 1.0 gram.

TABLE 5
Stevia-based Reb A Sweetener Formulation Compositions

| Formulation | Sweetener Product Composition | | | | |
|---|---|---|---|---|---|
| Number^{a} | Reb A Supplier | mg | % w/w | mg | % w/w |
| | | Reb A 97% | | Erythritol | |
| 0 | Shandong Huaxian | 18 | 1.8 | 982 | 98.2 |
| 1 | RioNatural | 10 | 1.0 | 990 | 99.0 |
| 2 | RioNatural | 15 | 1.5 | 985 | 98.5 |
| 3 | RioNatural | 18 | 1.8 | 982 | 98.2 |
| 4 | RioNatural | 20 | 2.0 | 980 | 98.0 |
| 5 | RioNatural | 25 | 2.5 | 975 | 97.5 |
| 6 | SGF | 10 | 1.0 | 990 | 99.0 |
| 7 | SGF | 15 | 1.5 | 985 | 98.5 |
| 8 | SGF | 18 | 1.8 | 982 | 98.2 |
| 9 | SGF | 20 | 2.0 | 980 | 98.0 |
| 10 | SGF | 25 | 2.5 | 975 | 97.5 |
| 11 | Shandong Huaxian | 20 | 2.0 | 980 | 98.0 |
| 12 | Shandong Huaxian | 15 | 1.5 | 985 | 98.5 |
| | | Glucosyl | | | |
| | | Stevioside 80% | | Lactose | |
| 13 | Shandong Huaxian | 80.0 | 8 | 920 | 92 |
| 14 | Shandong Huaxian | 80.0 | 8 | 920 | 92 |

Footnote:
^{a}Formulation numbers 0 through 5, 11 and 12 used Pure Reb A 97%, formulation numbers 6 through 10 used High Purity Reb A 97%.

The sweetener compositions described in Table 5 above are free-flowing, crystalline granular powders. The sweetener compositions contain either glucosyl stevioside 80% (Shandong Huaxian) or Pure Reb A 97% (Shandong Huaxian) in concentrations of 8.0% and 2.0%, respectively formulated with either erythritol or lactose. Samples were prepared by a wet granulation process and fluid bed drying, sifting (40 to 60 mesh) and packaging into 1 gram quantities into sachets equivalent in sweetness to 2 teaspoons of sugar.

### Example 3

The Stevia-based sweeteners described in Tables 5 were evaluated for sweetness and overall taste preference (likeness). Two packets or sachets of each product were added to 16 ounces of water. Formulation Nos. 3, 5, 8 and 10 consisting of 1 gram of 1.8% 2.5% Reb A 97% sourced from RioNatural (Pure Reb A 97%) and Sweet Green Fields (SGF High Purity Reb A 97%), and erythritol, respectively, were evaluated for taste. Each volunteer took a few sips of each formulation and drank a few sips of water between sampling each formulation. Sweeteners were rated for sweetness on a scale of 0 to 4 and were rated for over all taste on a scale of from −4 to +4 as follows:

### Scale Used for Sweetness

4=excellent sweetness
3=real good sweetness
2=acceptable sweetness
1=could do better in sweetness
0=poor sweetness
Scale Used for Likeness (Feel after Drinking):
−4=hate it
−3=dislike a lot
−2=dislike
−1=dislike somewhat
0=neutral
+1=like somewhat
+2=like it
+3=like a lot
+4=love it

The results of taste testing are provided below in Table 6.

TABLE 6
Taste test results of Sweetener Formulations containing Reb A 97%

| | Reb A 97% Source | | | | | | | |
|---|---|---|---|---|---|---|---|---|
| | RioNatural Reb A 97% | | | | SGF REB A 97% | | | |
| | (Sweetness, Likeness) | | | | (Sweetness, Likeness) | | | |
| | Formulation # | | | | | | | |
| Sub- | (3) 18 mg | | (5) 25 mg | | (8) 18 mg | | (10) 25 mg | |
| ject | Sweet | Like | Sweet | Like | Sweet | Like | Sweet | Like |
| 1 | 2 | +2.5 | 3 | +3 | 2 | 0 | 2 | +1 |
| 2 | 1 | +1 | 1 | +1 | 2 | +1 | 3 | +1 |
| 3 | 2 | +2 | 3 | −1 | 2 | +1 | 3 | −1 |
| 4 | 2 | +2 | 2 | +3 | 3 | +2 | 4 | +3 |
| Aver- | 1.75 | +1.88 | 2.25 | +1.5 | 2.25 | +1 | 3 | +1 |
| age | | | | | | | | |

Results: Among the 4 subjects, sweetener Formulation Nos. 8 and 10 containing 18 or 25 mg of High Purity Reb A 97% were slightly sweeter compared to Formulations 3 and 5 containing 18 mg and 25 mg of Pure Reb A 97%, respectively. Overall, all subjects like somewhat or like all formulations of the Stevia-based sweeteners.

RioNatural sweetener formulations dissolved in 30 seconds in refrigerated water. Highly purified Reb A 97% from Sweet Green Fields (SGF) sweetener formulations dissolved within 5 seconds in refrigerated water.

### Example 4

The Stevia-based sweeteners described in Table 5 were evaluated in additional subjects as in Example 3 for sweetness and overall taste preference (likeness). Two packets or sachets of each product were added to 16 ounces of water. Formulation Nos. 1, 3, 5, 6, 8 and 10 consisting of 1 gram of 1.0%, 1.8% and 2.5% Reb A 97% sourced from RioNatural (Pure Reb A 97%) and Sweet Green Fields (SGF High Purity Reb A 97%), and erythritol, respectively, were evaluated for taste. Each volunteer took a few sips of each formulation and drank a few sips of water between sampling each formulation. Sweeteners were rated for sweetness on a scale of 0 to 4 and were rated for over all taste on a scale of from −4 to +4 as in Example 7. The results of taste testing are provided in Table 7.

TABLE 7
Taste test results of sweetener formulations containing Pure Reb A 97% and High
Purity Reb A 97%

| | Reb A Source | | | | | | | | | | | |
|---|---|---|---|---|---|---|---|---|---|---|---|---|
| | RioNatural Reb A 97% (Sweetness, Likeness) | | | | | | SGF REB A 97% (Sweetness, Likeness) | | | | | |
| | Formulation # | | | | | | | | | | | |
| | (1) 10 mg | | (3) 18 mg | | (5) 25 mg | | (6) 10 mg | | (8) 18 mg | | (10) 25 mg | |
| Subject | Sweet | Like | Sweet | Like | Sweet | Like | Sweet | Like | Sweet | Like | Sweet | Like |
| 1 | 0.5 | +0.5 | 1 | +0.5 | 1.5 | +1.5 | 1 | 0 | 1.5 | +2 | 2 | +3 |
| 2 | 0 | +0.5 | 1 | +1 | 1.5 | +1.5 | 1 | +1 | 1 | +1 | 1.5 | +2 |
| 3 | 0 | 0 | 1 | −1 | 1.5 | −0.5 | 1 | −1 | 1 | +1 | 3 | +2 |
| 4 | 0.5 | 0 | 0.5 | −1.0 | 1.5 | −1.0 | 1 | +1 | 2 | +2.5 | 2.5 | +2 |
| 5 | 0.5 | 0 | 1 | +1 | 2 | +2 | 1 | +1 | 2 | +2 | 2.5 | +2 |
| 6 | 0.5 | −0.5 | 1 | −0.5 | 1.5 | +1.5 | 2 | 0 | 2.5 | +1.5 | 2.5 | +1.5 |
| Average | 0.33 | +0.08 | 0.92 | 0 | 1.6 | +0.83 | 1.2 | +0.33 | 1.7 | +1.6 | 2.33 | +2.1 |

Results: The results from a taste testing study performed using a 1 gram of sweetener formulations of 1%, 1.8% 2.5% Reb A 97% sourced from Sweet Green Fields (SGF High Purity Reb A 97%) and RioNatural (Pure Reb A 97%) along with the remaining erythritol is summarized in Table 13. The degree of sweetness increased with increasing concentrations of Reb A 97%. Sweetness of formulations using High Purity Reb A 97% from SGF was greater compared to the same concentrations of Pure Reb A 97% from RioNatural. The overall taste of formulations using the High Purity Reb A 97% from SGF was superior to the Pure Reb A 97% from RioNatural. Formulation No 10 based on 2.5% or 25 mg of High Purity Reb A 97% from SGF had the best sweetness and overall taste compared to the other formulations in Table 7.

### Example 5

Focused taste testing of the characteristics of sweetness, bitterness, sourness, saltiness, other tastes, mouth feel and global taste assessment were conducted in human subjects. The following Stevia based products (see Table 5) containing High Purity Reb A (Rebaudioside A 97%) from Sweet Green Fields (SGF), Bellingham, Wash. 98225 and from RioNatural (RN), China were formulated with erythritol at 5 concentrations of High Purity Reb A 97% (1, 1.5, 1.8, 2 and 2.5 wt. %) and were compared for organoleptic taste attributes and the appropriate non-sweetened control beverage.

### Preparation of Beverages

The following non-sweetened (control) and sweetened water was tested following preparation. One packet of each sweetener or 2 teaspoons of Table Sugar (comparative control) were added to a 16 ounce glass of water at room temperature.

### Water:

Water was obtained from the tap and 16 ounces measured using a measuring cup and placed into a 16 ounce glass. The sweetener (one packet or 2 teaspoons of sugar) was added to the water, stirred with a spoon, time of dissolution recorded and then poured into smaller glasses or cups containing a few ounces for taste testing by each volunteer.

Taste Evaluation:

A taste test of the products was performed by healthy adult subjects (males and females at least 18 years of age, N=4-6). Prior to tasting, the subjects were informed about the purpose of the tasting and the possible adverse bitter taste with some of the Reb A containing products. Subjects first rinsed their mouths thoroughly before and after tasting each product with a 6 ounces of tap water. Each beverage was sipped (a large mouth-full) once and held in the mouth for 30 seconds and then swallowed, and the taste was then immediately evaluated over a period of 1 minute and any bitter aftertaste was evaluated after 1 minute. The following scoring system was used and assigned a numerical value according to the scales outlined below:

### Organoleptic Attributes:

The following attributes were rated immediately after tasting and over a 1 minute period (sweet, bitter, sour, salty, other taste—describe it, mouth feel, mouth sensation, overall taste evaluation.

### Sweet

0=none
1=very slight (some sweetness)
2=slight (noticeable sweetness)
3=moderate (intense sweetness)
4=high (very intense sweetness)

### Bitter

0=none
1=very slight (some bitterness)
2=slight (noticeable bitterness)
3=moderate (intense bitterness)
4=high (very intense bitterness)

### Sour

0=none
1=very slight (some sourness)
2=slight (noticeable sourness)
3=moderate (intense sourness)
4=high (very intense sourness)

### Salty

0=none
1=very slight (some saltiness)
2=slight (noticeable saltiness)
3=moderate (intense saltiness)
4=high (very intense saltiness)

### Other Taste

0=none
1=very slight (describe it)
2=slight (describe it)
3=moderate (describe it)
4=high (describe it)

### Mouth Feel

0=very poor (unacceptable, would not use it again)
1=poor (not desirable, might not use it again)
2=mediocre (acceptable, might use it again)
3=very good (desirable, would use it again)
4=excellent (very desirable, would use it again)

| Mouth Sensation | Intensity |
|---|---|
| A = Burning | 0 = none |
| B = Numbing (anesthetic-like) | 1 = very slight |
| C = Itching | 2 = slight |
| D = Pain | 3 = moderate |
| E = Other (describe it) | 4 = high/severe |

### Overall Global Taste Evaluation

0=very poor (unacceptable, would not use it again)
1=poor (not desirable, might not use it again)
2=mediocre (acceptable, might use it again)
3=very good (desirable, would use it again)
4=excellent (very desirable, would use it again)

The scores were recorded on rating forms and the mean, standard deviation (SD) and coefficient of variation (CV %) was determined. The results are summarized in Tables 8 to 9 below.

Results: The results of taste testing of the sweetener formulations in room temperature tap water are summarized in Tables 8 and 9 and are discussed as follows:

Controls and Comparators: The tap water control had a very slight perception of a combination of bitterness, sour and salty taste in some subjects illustrating the variability inherent in individuals and their taste perception. In general, water had a baseline mouth feel and global taste evaluation of between poor and mediocre (score of 1.5), however, no subject perceived it as sweet. In contrast, Table Sugar had a perception of slight sweetness (mean=2.0) and varying perceptions of bitter and salty similar to the unsweetened tap water in some subjects. In general, Table Sugar had a mean baseline mouth feel and global taste evaluation score of mediocre (mean=2.0), however, no subject perceived it as bitter. Equal was sweeter than table Sugar with an average sweetness of between moderate to high (Mean=3.3), with varying very slight perceptions of bitter and sour in some subjects. In general, Equal had a mean baseline mouth feel and global taste evaluation score of between mediocre and very good (mean=2.8), however, no subject perceived it as salty and only 1 of 4 subjects perceived it as slightly bitter. However, overall Equal was superior to Table Sugar on terms of mouth feel and overall taste.

High Purity Stevia Sweetener Formulations 1 to 10: The Stevia containing sweeteners used in Formulation Nos. 1 to 5 were formulated with non-GRAS certified Reb A 97% obtained from RioNatural, while Formulations Nos. 6 to 10 used GRAS certified Reb A 97% obtained from Sweet Green Fields. Reb A 97% obtained from SGF employ a manufacturing process that removes the impurities of the other bitter steviol glycosides and steviosides and have a specification of less than 3% of other related steviol glycosides. The sweetener compositions of Formulations Nos. 1 to 10 are specified in Table 5 and contained concentrations of 1.0, 1.5, 1.8, 2.0 and 2.5% of high purity Reb A 97% with the balance being erythritol.

The results are presented in Table 8 below. All sweetener formulations dissolved in room temperature tap water in less than 60 seconds. The general trends observed included an increase in sweetness and an increase in overall global taste preference with an increase in the high purity Reb A 97% content (Formulations 1 to 10). Some formulations had no or very slight to moderate bitter taste in some subjects.

The best sweetener composition using Reb A 97% from RioNatural was Formulation No. 5 which had a mean bitter score of only 0.3, a sweetness score of 2.3, mouth feel score of 2.0 and overall global taste evaluation score of 2.0, and only 1 out of 4 subjects perceived a slight bitter taste.

The best sweetener composition using High Purity Reb A 97% from SGF was Formulation No. 9 containing 2.0% Reb A which had a mean bitter score of only 0.5, a sweetness score of 2.5, mouth feel score of 1.9 and had a mediocre to good overall global taste evaluation (mean=2.3) and only 1 out of 4 subjects perceived a very slight bitter taste.

Formulation No. 9 was comparable to Formulation No. 5. Formulation No. 9 contained 2% of pure Reb A 97% from SGF and was slightly sweeter compared to sugar and slightly better in overall global taste assessment compared to sugar.

TABLE 8
Taste test results of sweetener formulations containing Pure Reb A 97% and High Purity Reb A 97%

| | Organoleptic Evaluation of Taste Attributes of Controls and Sweeteners Containing Reb A 97% (N = 4) | | | | | | | | | | | | | |
|---|---|---|---|---|---|---|---|---|---|---|---|---|---|---|
| | | | | | Stevia-Based Sweeteners Containing Reb A 97% and Formulation Numbers | | | | | | | | | |
| | Comparator controls | | | | Reb A 97% From RioNatural | | | | | | | | | |
| Organoleptic | Water Control | | Sugar Control | | 1 | | 2 | | 3 | | 4 | | 5 | |
| Attributes | Mean | SD | Mean | SD | Mean | SD | Mean | SD | Mean | SD | Mean | SD | Mean | SD |
| Sweet | 0.0 | 0.0 | 2.0 | 0.0 | 1.0 | 0.0 | 1.5 | 1.3 | 2.0 | 0.8 | 1.8 | 1.0 | 2.3 | 0.5 |
| Bitter | 0.3 | 0.5 | 0.3 | 0.5 | 1.5 | 1.7 | 1.5 | 1.3 | 1.0 | 2.0 | 0.0 | 0.0 | 0.3 | 0.5 |
| Sour | 0.3 | 0.5 | 0.0 | 0.0 | 0.3 | 0.5 | 0.0 | 0.0 | 0.3 | 0.5 | 0.8 | 1.5 | 0.3 | 0.5 |
| Salty | 0.5 | 1.0 | 0.3 | 0.5 | 1.3 | 1.3 | 1.0 | 1.4 | 0.5 | 0.6 | 0.8 | 1.5 | 0.5 | 1.0 |
| Other taste | 0.0 | 0.0 | 0.0 | 0.0 | 0.0 | 0.0 | 0.0 | 0.0 | 0.0 | 0.0 | 0.0 | 0.0 | 0.0 | 0.0 |
| (describe) | | | | | | | | | | | | | | |
| Mouth Feel | 1.3 | 1.0 | 2.0 | 0.8 | 1.5 | 0.6 | 1.3 | 0.5 | 1.5 | 0.6 | 1.5 | 0.6 | 2.0 | 0.8 |
| Mouth | 0.0 | 0.0 | 0.0 | 0.0 | 0.0 | 0.0 | 0.0 | 0.0 | 0.0 | 0.0 | 0.0 | 0.0 | 0.0 | 0.0 |
| Sensation | | | | | | | | | | | | | | |
| (letter and | | | | | | | | | | | | | | |
| score) | | | | | | | | | | | | | | |
| Global Taste | 1.5 | 0.6 | 2.0 | 0.8 | 1.0 | 0.0 | 1.0 | 0.8 | 1.5 | 0.6 | 1.8 | 0.5 | 2.0 | 0.8 |
| Evaluation | | | | | | | | | | | | | | |

| | | | | | | | |
|---|---|---|---|---|---|---|---|
| Comments: | Tap Water at | Added 1 packet | Added 1 packet | Added 1 packet (1 | Added 1 packet | Added 1 packet (1 | Added 1 packet |
| | room | (1 gram) in 16 | (1 gram) in 16 | gram) in 16 | (1 gram) in 16 | gram) in 16 | (1 gram) in 16 |
| | temperature | ounces of tap | ounces of tap | ounces of tap | ounces of tap | ounces of tap | ounces of tap |
| | approximately | water. Dissolved | water at RT. | water at RT. | water at RT. | water at RT. | water. Dissolved |
| | 70 degrees F. | in 35 seconds. N = | Dissolved in 40 | Dissolved in 40 | Dissolved in 43 | Dissolved in 20 | in 35 seconds. N = |
| | | 3/4 had very | seconds. N = | seconds. GP had | seconds. N = | seconds. N = 1/4 | 3/4 had very |
| | | slight to high | 3/4 had a very | slight tingling | 4/4 had no | had a very slight | slight to high |
| | | bitter taste. | slight to | sensation. N = 1/4 | bitter taste. | bitter taste. | bitter taste. |
| | | | moderate bitter | had a high bitter | | | |
| | | | taste. | taste. | | | |

TABLE 9
Taste test results of formulations containing Pure Reb A 97% and High Purity Reb A 97%

| | Organoleptic Evaluation of Taste Attributes of Controls and Sweeteners Containing Reb A 97% (N = 4) | | | | | | | | | | | | | |
|---|---|---|---|---|---|---|---|---|---|---|---|---|---|---|
| | Comparator controls | | | | Stevia-Based Sweeteners Containing Reb A 97% and Formulation Numbers | | | | | | | | | |
| | Water | | Sugar | | Reb A 97% from Sweet Green Fields (GRAS) | | | | | | | | | |
| Organoleptic | Control | | Control | | 6 | | 7 | | 8 | | 9 | | 10 | |
| Attributes | Mean | SD | Mean | SD | Mean | SD | Mean | SD | Mean | SD | Mean | SD | Mean | SD |
| Sweet | 0.0 | 0.0 | 2.0 | 0.0 | 1.0 | 0.0 | 1.5 | 1.0 | 2.3 | 1.0 | 2.5 | 0.6 | 2.0 | 0.8 |
| Bitter | 0.3 | 0.5 | 0.3 | 0.5 | 0.0 | 0.0 | 0.3 | 0.5 | 1.0 | 1.2 | 0.5 | 1.0 | 0.8 | 1.0 |
| Sour | 0.3 | 0.5 | 0.0 | 0.0 | 0.3 | 0.5 | 1.0 | 0.8 | 0.3 | 0.5 | 0.0 | 0.0 | 0.8 | 1.0 |
| Salty | 0.5 | 1.0 | 0.3 | 0.5 | 0.3 | 0.5 | 0.5 | 1.0 | 0.5 | 0.6 | 0.0 | 0.0 | 1.3 | 1.9 |
| Other taste | 0.0 | 0.0 | 0.0 | 0.0 | 0.0 | 0.0 | 0.0 | 0.0 | 0.0 | 0.0 | 0.5 | 1.0 | 0.0 | 0.0 |
| (describe) | | | | | | | | | | | | | | |
| Mouth Feel | 1.3 | 1.0 | 2.0 | 0.8 | 1.8 | 0.5 | 1.5 | 1.3 | 1.8 | 0.5 | 2.1 | 0.3 | 1.8 | 1.3 |
| Mouth | 0.0 | 0.0 | 0.0 | 0.0 | 0.0 | 0.0 | 0.0 | 0.0 | 0.0 | 0.0 | 0.0 | 0.0 | 0.0 | 0.0 |
| Sensation | | | | | | | | | | | | | | |
| (letter and | | | | | | | | | | | | | | |
| score) | | | | | | | | | | | | | | |
| Global Taste | 1.5 | 0.6 | 2.0 | 0.8 | 1.5 | 1.0 | 1.5 | 1.3 | 1.8 | 0.5 | 2.3 | 1.0 | 1.8 | 1.0 |
| Evaluation | | | | | | | | | | | | | | |

| | | | | | | | |
|---|---|---|---|---|---|---|---|
| Comments: | Tap Water | Dissolved 2 | Added 1 packet | Added 1 packet (1 | Added 1 packet | Added 1 packet | Dissolved 1 gram |
| | at room | Teaspoons in 16 | (1 gram) in 16 | gram) in 16 | (1 gram) in 16 | (1 gram) in 16 | in a 16 ounce |
| | temperature | ounces of tap | ounces of tap | ounces of tap | ounces of tap | ounces of tap | glass of tap water |
| | approximately | water (equivalent | water at RT. | water. Dissolved | water. Dissolved | water at RT. | at RT. Dissolved |
| | 70 degrees F. | to 8 grams of | Dissolved in | in 25 seconds. B1 = | in 25 seconds. | Dissolved in about | in 5 sec. No |
| | | sugar). Dissolved | about 60 | very slight | DP had a bitter | 1 min. Other | lingering sweet |
| | | in about 1 min. | seconds. E2 = | numbing | aftertaste after 2 | Taste: DJ. Slight | or bitter |
| | | | very slight | sensation. N = 1/4 | minutes. N = 2/4 | Pool water taste | aftertaste. N = |
| | | | tingling on | had very slight | had slight bitter | like chlorine. N = | 2/4 had very |
| | | | underside of | bitter taste. | taste. | 1/4 had very slight | slight to slight |
| | | | tongue. N = 4/4 | | | bitter taste. | bitter taste. |
| | | | had No bitter | | | | |
| | | | taste. | | | | |

### Example 6

The taste of sweetener Formulation No. 9 (Table 5) crystals and water solution were compared to water, sugar crystals and PureVia® crystal which were obtained from retail stores. Crystals of each product were touched to the index finger and placed in the mouth and rated after 30 seconds in terms of sweet, bitter, sour, salty, mouth feel and global taste evaluation as defined in Example 5. The data is provided in Table 10. Formulation No. 9 crystals were sweeter than sugar and PureVia® crystals and had a superior overall global taste score compared to sugar and PureVia® crystals.

TABLE 10
Taste attributes of controls and marketed sweetener products compared to Stevia formulation no. 9

| | Replicates (N = 4) | | | | | | | | | |
|---|---|---|---|---|---|---|---|---|---|---|
| | | | | | Stevia-Based Sweeteners | | | | | |
| | Comparator Controls | | | | | | Formulation | | Formulation | |
| | Water | | | | PureVia | | No. 9 | | No. 9 | |
| Organoleptic | Control | | Sugar Crystals | | Crystals | | Crystals | | Water | |
| Attributes | Mean | SD | Mean | SD | Mean | SD | Mean | SD | Mean | SD |
| Sweet | 0.0 | 0.0 | 2.8 | 1.0 | 3.0 | 1.4 | 4.0 | 0.0 | 1.5 | 1.3 |
| Bitter | 0.3 | 0.6 | 0.3 | 0.5 | 0.8 | 1.5 | 0.3 | 0.5 | 1.3 | 1.9 |
| Sour | 0.0 | 0.0 | 0.0 | 0.0 | 0.8 | 1.5 | 0.0 | 0.0 | 0.0 | 0.0 |
| Salty | 0.0 | 0.0 | 0.0 | 0.0 | 0.5 | 1.0 | 0.0 | 0.0 | 0.8 | 1.0 |
| Mouth Feel | 0.7 | 1.2 | 2.0 | 0.0 | 1.5 | 1.3 | 4.0 | 0.0 | 1.8 | 1.3 |
| Global Taste | 0.7 | 1.2 | 2.3 | 0.5 | 2.0 | 1.4 | 4.0 | 0.0 | 1.5 | 1.3 |
| Evaluation | | | | | | | | | | |

| | | | | | |
|---|---|---|---|---|---|
| Comments: | Water at room | Placed | Placed | Placed | Dissolved 1 |
| | temperature | approximately | approximately | approximately | packet in |
| | approximately | 1 gram on a | 1 gram on a | 1 gram on a | 16 ounces |
| | 60 degrees F. | paper plate. | paper plate. | paper plate. | of tap water |
| | | | | | (well water) |
| | | | | | and stirred |
| | | | | | with spoon. |
| | | | | | Dissolved |
| | | | | | in 27 seconds. |

### Example 7

The taste of sweetener Formulation No. 9 (Table 5) was compared to other leading selling Stevia-based sweeteners including Truvia®, PureVia® and Sweet Leaf® which were obtained from retail stores. Crystals of each product were placed in the mouth and rated in terms of aftertaste, negative comments and overall rank order of preference (Table 10). Formulation No. 9 had no aftertaste or negative comments and was preferred by consumers over the other Stevia containing sweetener products.

TABLE 11
Taste attributes of Stevia sweeteners
Taste Attributes of Stevia Sweeteners

| | Formulation | | | Sweet |
|---|---|---|---|---|
| Taste Attribute | No. 9 | Truvia ® | PureVia ® | Leaf ® |
| Aftertaste Percent | 0% | 56% | 78% | 100% |
| Negative Comments | 0% | 0% | 33% | 44% |
| Percent | | | | |
| Normalized Taste | 1 | 2 | 3 | 4 |
| Rank Order | | | | |

### Example 8

### Manufacture by Spray Drying Using Isopropyl Alcohol

A 32 Kg batch size targeted to produce 32,000 sachets of sweetener Formulation No. 11 was manufactured as described (See Table 3). First, sifting and dry mixing was carried out by passing 0.640 Kg of Rebaudioside A 97% and 31.360 Kg of erythritol through a Sifter with a 40 mesh stainless steel sieve. The formulation was transferred into a RMG mixer and mixed for 20 minutes. Then 4.5 Kg of isopropyl alcohol (IPA) was added into the RMG mixer and mixed for 15 minutes with chopping. A number 3 chopper blade was started after 10 minutes of mixing and run for 3 minutes to obtain uniform fine granules. Granules were unloaded and conveyed by a pneumatic device into a fluid bed dryer during continuous mixing. The semi-drying operation was carried out for 45 minutes at 65 degree C. inlet temperature and 50 degrees C. outlet temperature. After completion of semi-drying, the semi-dried material of the bowl was passed through a Turbo Shifter using a 4 mm stainless steel screen and granules were collected into a clean vessel. The process resulted in 31.320 Kg of sweetener composition (Formulation No. 11) with a moisture content of 0.2% determined with an I.R. Moisture Balance.

Finally, the material was then passed through a Turbo Shifter using 2.5 mm stainless steel screen and shifted through a #16 sieve. Then 1 gram of the formulation was filled into sachets using a sachet filling machine resulting in manufacture of 28,728 sachets or an 89.8% yield.

### Example 9

### Manufacture of Sweetener Formulation No. 9 by Wet Granulation Using Water

A 150 Kg batch size targeted to produce 150,000 (1 gram sachets) of sweetener Formulation No. 9 was manufactured from a batch containing 3.12 Kg of Reb A 97% FCC (Sweet Green Fields), 147.88 Kg of erythritol FCC (Anil Starch) and 12 L of purified water to produce a dried composition of 2.0 wt. % of Reb A 97% and 98 wt. % erythritol. A 147 Kg of erythritol was sifted in a Multimill through a 1 mm stainless steel screen. A volume of 12 L of purified water was added to a 15 liter mixer and 3.120 Kg of Reb A 97% was added and mixed until completely dissolved. Erythritol was transferred to a rapid mixer granulator. The water solution of Reb A 97% was transferred evenly into the rapid mixer granulator containing erythritol and mixed for 3 minutes. The wet granules were unloaded and dried in a FBD bowl at an inlet temperature of 70° C. and outlet temperature of 50° C. for 45 min. The dried granules were passed through a Multimill over a 0.5 mm stainless steel screen and sifted through a 40 mesh screen. The sifted granules were loaded into an octagonal blender and mixed for 15 min. The 149.0 Kg of bulk product was then packaged into approximately 150,000 sachets containing 1 gram of sweetener.

### Example 10

### Manufacture by Spray Drying Using Water

A 32 Kg batch size targeted to produce 32,000 sachets of sweetener Formulation No. 9 is manufactured as described (See Table 5). First, sifting and dry mixing is carried out by passing 0.640 Kg of Rebaudioside A 97% and 31.360 Kg of erythritol through a Sifter with a 40 mesh stainless steel sieve. The formulation is transferred into a RMG mixer and mixed for 20 minutes. Then 4.5 Kg of water is added into the RMG mixer and mixed for 15 minutes with chopping. A number 3 chopper blade is started after 10 minutes of mixing and run for 3 minutes to obtain uniform fine granules. Granules are unloaded and conveyed by a pneumatic device into a fluid bed dryer during continuous mixing. The semi-drying operation is carried out for 45 minutes at 65 degree C. inlet temperature and 50 degrees C. outlet temperature. After completion of semi-drying, the semi-dried material of the bowl is passed through a Turbo Shifter using a 4 mm stainless steel screen and granules are collected into a clean vessel. The process results in 31.320 Kg of sweetener composition (Formulation No. 11) with a moisture content of 0.2% determined with an I.R. Moisture Balance.

### Example 11

### Manufacturing by Fluid Bed Drying Process

The process is carried out using a three-nozzle Model 3200 Wurster fluid bed. The fluid bed uses a bottom spray with PTFE coating filter socks. A fluidizing distribution plate is set up for coating process with higher air flow at the center. The air is cycled back through the filter socks in knock-back mode to reduce build-up of fines.

An erythritol coating solution is prepared by mixing erythritol with purified water to obtain a 30% solids solution. The mixture is heated to room temperature to aid in dissolution.

The dry ingredients are introduced into a bowl. The dry ingredients include erythritol, rebaudioside A, and any other additives (e.g., sweetness modifier, mouth feel enhancer, and flavorants).

The fluid bed is preheated to about 75 degree C. The dry ingredients are charged to the fluid bed, and are fluidized and blended for several minutes. The dry product is maintained at a temperature of about 82 degree C., and the fluidizing air temperature ranges from about 100 to about 150 degree C. The erythritol coating solution is introduced through the bottom of the fluid bed with a spray rate of 780-850 g/min and an atomizing air pressure of about 60 psi. The coating process is carried out until the dry particles are substantially coated by the coating solution (e.g., about 4-6 minutes). When about 2-3 minutes remain in the coating process, lactose is sucked into the fluid bed, where it attaches to the outside of partially coated particles in the fluid bed. The coating process continues for an additional 2-3 minutes after introduction of the lactose. When the coating step is complete, the fluidizing air temperature is increased to about 150 degree C. to dry the product. Once the product is dry, the temperature is reduced.

The product is screened using a Sweco screening apparatus. Only particles having a size between 16 mesh (or 14 mesh, or 12 mesh) and 100 mesh are accepted (based on standard United States sieve scale). If any clumping or balling has occurred, the larger particles are broken up on the screen.

What is claimed is:

1. A natural sweetener composition, comprising:
a purified Stevia extract, having a pure primary steviol glycoside, and
a bulking agent selected from the group consisting of sugar alcohols, disaccharides, and monosaccharides.

2. The natural sweetener composition of claim 1, wherein said purified Stevia extract comprises a pure primary steviol glycoside and other steviol glycosides.

3. The natural sweetener composition of claim 1, wherein said pure primary steviol glycoside is High Purity Reb A, High Purity Stevioside, or High Purity Glucosyl Stevioside.

4. The natural sweetener composition of claim 2, wherein said other steviol glycosides are less than 3 percent purity.

5. The natural sweetener composition of claim 3, wherein said High Purity Reb A comprises a steviol glycoside of rebaudioside A having at least 97 percent purity, other steviol glycosides having less that 3 percent purity, and sterebins having less than 1 percent purity.

6. The natural sweetener composition of claim 1, wherein said sugar alcohol is selected from the group consisting of arabitol, dulcitol, erythritol, glycerol, hydrogenated isomaltulose, hydrogenated starch hydrolyzates, iditol, isomalt, lactitol, maltitol, mannitol, polyglycitol, ribitol, sorbitol, threitol, xylitol, and combinations thereof.

7. The natural sweetener composition of claim 6, wherein said sugar alcohol is erythritol.

8. The natural sweetener composition of claim 1, wherein said disaccharide is selected from the group consisting of maltose, lactose, sucrose, isomaltulose, maltulose, isomaltose, cellobiose, and combinations thereof.

9. The natural sweetener composition of claim 1, wherein said monosaccharide comprises glucose, galactose, xylose and ribose.

10. The natural sweetener composition of claim 1, further comprising an additive selected from the group consisting of binders, flavorants, nutritional ingredients, and aroma components.

11. The natural sweetener composition of claim 1, wherein said purified Stevia extract is about 0.5 to 10 percent by weight and said bulking agent is about 80 to 99 percent by weight.

12. The natural sweetener composition of claim 1, wherein said purified Stevia extract is about 1.5 to 5 percent by weight and said bulking agent is about 80 to 98.5 percent by weight.

13. The natural sweetener composition of claim 1, wherein said purified Stevia extract is about 2.5 percent by weight and said bulking agent is about 97.5 percent by weight.

14. The natural sweetener composition of claim 3, wherein said pure primary steviol glycoside is about 2 percent by weight and said bulking agent is about 98 percent by weight.

15. The natural sweetener composition of claim 14, wherein said pure primary steviol glycoside is High Purity Reb A and said bulking agent is erythritol.

16. The natural sweetener composition according to claim 10, wherein said purified Stevia extract is about 0.5 to 10 percent by weight, said bulking agent is about 80 to 99 percent by weight, and said additive is at about up to 5 percent by weight of the resulting combination.

17. A method of preparing a naturally sweetened orally administered product, comprising the steps of:
formulating a natural sweetener composition and
combining the natural sweetener composition, in a concentration amount to sweeten said orally administered product, with other ingredients commonly used to manufacture said orally administered product.

18. The orally administered product as defined in claim 17, wherein said orally administered product is selected from the group consisting of pharmaceutical products, nutritional supplements, herbal supplements, food products, and beverage products.

19. The orally administered product as defined in claim 18, wherein the concentration amount of said natural sweetener composition is between about 0.5 to about 10 percent by weight to weight of said nutritional supplements, herbal supplements, food products, and pharmaceutical products in solid form, and between about 0.5 to 10 percent weight to volume of said beverage products and pharmaceutical products in liquid form.

20. The process for the preparation of a natural sweetener composition, which comprising the steps of:
formulating a natural sweetener composition;
dry mixing the natural sweetener composition;
dissolving the dry-mixed natural sweetener composition in an aqueous solvent
selected from a group consisting of water and organic solvents;
drying the dissolved natural sweetener composition, and
passing the dried natural sweetener composition through a particle sieve.
